(19) United States
(12) Patent Application Publication
(10) Pub. No.: US 2024/0364435 A1
(43) Pub. Date: Oct. 31, 2024

(54) RADIO WAVE PROPAGATION ANALYSIS DEVICE, RADIO WAVE PROPAGATION ANALYSIS METHOD, AND RECORDING MEDIUM

(71) Applicant: Mitsubishi Electric Corporation, Tokyo (JP)

(72) Inventors: Takuro MAMIYA, Tokyo (JP); Takayuki NAKANISHI, Tokyo (JP); Michio TAKIKAWA, Tokyo (JP); Yasuhiro NISHIOKA, Tokyo (JP)

(73) Assignee: Mitsubishi Electric Corporation, Tokyo (JP)

(21) Appl. No.: 18/767,103

(22) Filed: Jul. 9, 2024

Related U.S. Application Data
(63) Continuation of application No. PCT/JP2022/003914, filed on Feb. 2, 2022.

(51) Int. Cl. H04B 17/309; G06F 16/29

(52) U.S. Cl. CPC H04B 17/309; G06F 16/29

(57) ABSTRACT

A radio wave propagation analysis device includes a simplified map information generating unit to acquire map information including building information and open space region information corresponding to the map information, generate block region information in which a region obtained by excluding a region indicated by the open space region information from a map indicated by the map information is set as a block region, and generate simplified map information in which the map information is simplified in which the region obtained by excluding the region indicated by the open space region information is changed to a block region indicated by the block region information, and a radio wave propagation analysis unit to perform radio wave propagation analysis on the basis of the simplified map information.

### CROSS REFERENCE TO RELATED APPLICATIONS

This application is a Continuation of PCT International Application No. PCT/JP2022/003914, filed on Feb. 2, 2022, all of which is hereby expressly incorporated by reference into the present application.

### TECHNICAL FIELD

The present disclosure relates to a radio wave propagation analysis device that performs analysis of radio wave propagation from a transmission point to a reception point in a communication system.

### BACKGROUND ART

Non Patent Literature 1 discloses an examination result of acceleration of ray tracing by simplifying a structure and reducing the number of reflection surfaces using a ray tracing method which is one of radio wave propagation analysis methods.

Non Patent Literature 1 uses an area in front of a station in Kokurakita-ku, Kitakyushu city as an analysis model, and uses a method of reducing the number of buildings by detecting a convex hull from a set of two-dimensional plane vertexes obtained by viewing a group of buildings of an urban area from above and replacing the convex hull with one building.

### CITATION LIST

### Non Patent Literature

Non Patent Literature 1: Kenshi Horihata, Rei Hasegawa, Yuzo Moriuchi, Hiroshi Satoh, Yoshio Koyanagi, Yasufumi Ichikawa, “A Study of Ray Trace Acceleration Method by Convex Hull Detection and Multiple Simple Path Searches”, IEICE Technical Report A, P 2020-11 (2020-07) pp. 9-14

### SUMMARY OF INVENTION

### Technical Problem

In the technique disclosed in Non Patent Literature 1, when a point set is defined on a two-dimensional plane or a minimum convex set including all given sets, buildings are aggregated by a convex hull given by a convex polygon.

Therefore, in an area aggregated as one building, a region where no building originally exists, such as a road existing between buildings, may be included in the one building.

A road existing between buildings may also be a main propagation path.

In addition, in an actual communication system, there are many cases where a wireless terminal is present on a road existing between buildings.

Therefore, when a structure is simplified by aggregating buildings with a convex hull, there is a factor that main propagation paths and transmission/reception point positions are buried in the aggregated structure, resulting in degradation of analysis accuracy or incapability of analysis.

The present disclosure has been made in view of the above points, and an object of the present disclosure is to obtain a radio wave propagation analysis device in which a factor that results in degradation of analysis accuracy or incapability of analysis is eliminated as much as possible, and a calculation amount required for radio wave propagation analysis is reduced.

### Solution to Problem

A radio wave propagation analysis device according to the present disclosure includes a processor; and a memory storing a program performing, upon executed by the processor, a process: to acquire map information including building information and open space region information corresponding to the map information, generate block region information in which a region obtained by excluding a region indicated by the open space region information from a map indicated by the map information is set as a block region, and generate simplified map information in which the map information is simplified in which the region obtained by excluding the region indicated by the open space region information is changed to a block region indicated by the block region information; and to perform radio wave propagation analysis on the basis of the simplified map information.

### Advantageous Effects of Invention

According to the present disclosure, simplified map information using open space region information is generated, and radio wave propagation analysis is performed on the basis of the simplified map information, so that degradation of analysis accuracy can be prevented, and an amount of calculation required for the radio wave propagation analysis can be reduced to accelerate calculation processing.

### BRIEF DESCRIPTION OF DRAWINGS

FIG. 1 is a configuration diagram illustrating a radio wave propagation simulator including a radio wave propagation analysis device according to a first embodiment.

FIG. 2 is a diagram illustrating a map formed by a two-dimensional plane obtained by viewing an urban area indicated by map information from above, which is stored in a map information storage unit of a storage unit in the radio wave propagation simulator according to the first embodiment.

FIG. 3 is a diagram in which only buildings are extracted from the map illustrated in FIG. 3.

FIG. 4 is a diagram illustrating a map formed by a two-dimensional plane obtained by viewing roads indicated by road information that is open space information from above, which is stored in an open space information storage unit of the storage unit in the radio wave propagation simulator according to the first embodiment.

FIG. 5 is a diagram illustrating a simplified map indicated by simplified map information generated by a simplified map information generating unit of the radio wave propagation analysis device in the radio wave propagation simulator according to the first embodiment.

FIG. 6 is a diagram schematically illustrating, in three dimensions, buildings existing in one block region stored in the map information storage unit of the radio wave propagation analysis device in the radio wave propagation simulator according to the first embodiment.

FIG. 7 is a diagram schematically illustrating, in three dimensions, a block region indicated by block region information on the basis of information indicating a building present in the one block region illustrated in FIG. 6.

FIG. 8 is a configuration diagram illustrating a hardware configuration of a radio wave propagation analysis device in the radio wave propagation simulator according to the first embodiment.

FIG. 9 is a flowchart illustrating an operation of the radio wave propagation analysis device in the radio wave propagation simulator according to the first embodiment.

FIG. 10 is a diagram illustrating a map formed by a two-dimensional plane obtained by viewing a river indicated by river region information as open space information from above, which is stored in an open space information storage unit of a storage unit in a radio wave propagation simulator according to a second embodiment.

FIG. 11 is a diagram illustrating a simplified map indicated by simplified map information generated by a simplified map information generating unit of a radio wave propagation analysis device in the radio wave propagation simulator according to the second embodiment.

FIG. 12 is a diagram illustrating a map formed by a two-dimensional plane obtained by viewing a track indicated by track region information as open space information from above, which is stored in an open space information storage unit of a storage unit in a radio wave propagation simulator according to a third embodiment.

FIG. 13 is a diagram illustrating a simplified map indicated by simplified map information generated by a simplified map information generating unit of a radio wave propagation analysis device in the radio wave propagation simulator according to the third embodiment.

FIG. 14 is a diagram illustrating a simplified map indicated by simplified map information generated by a simplified map information generating unit of a radio wave propagation analysis device in a radio wave propagation simulator according to a fourth embodiment.

FIG. 15 is a configuration diagram illustrating a radio wave propagation simulator including a radio wave propagation analysis device according to a fifth embodiment.

FIG. 16 is a diagram illustrating a simplified map indicated by simplified map information generated by a simplified map information generating unit of the radio wave propagation analysis device in the radio wave propagation simulator according to the fifth embodiment.

FIG. 17 is a flowchart illustrating an operation of the radio wave propagation analysis device in the radio wave propagation simulator according to the fifth embodiment.

FIG. 18 is a configuration diagram illustrating a radio wave propagation simulator including a radio wave propagation analysis device according to a sixth embodiment.

FIG. 19 is a diagram illustrating a simplified map indicated by simplified map information generated by a simplified map information generating unit of the radio wave propagation analysis device in the radio wave propagation simulator according to the sixth embodiment.

FIG. 20 is a configuration diagram illustrating a radio wave propagation simulator including a radio wave propagation analysis device according to a seventh embodiment.

FIG. 21 is a diagram illustrating a simplified map indicated by simplified map information generated by a simplified map information generating unit of the radio wave propagation analysis device in the radio wave propagation simulator according to the seventh embodiment.

FIG. 22 is a diagram illustrating a simplified map indicated by simplified map information generated by a simplified map information generating unit of a radio wave propagation analysis device in a radio wave propagation simulator according to an eighth embodiment.

FIG. 23 is a diagram illustrating a simplified map indicated by simplified map information generated by a simplified map information generating unit of a radio wave propagation analysis device in a radio wave propagation simulator according to a ninth embodiment.

### DESCRIPTION OF EMBODIMENTS

### First Embodiment

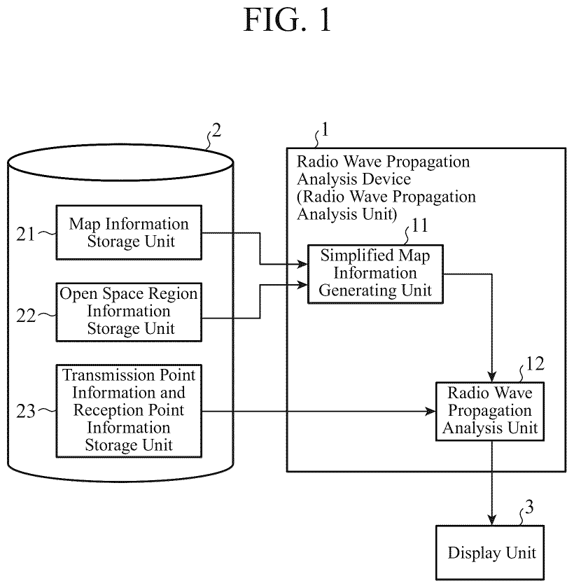

A radio wave propagation simulator including a radio wave propagation analysis device 1 according to a first embodiment will be described with reference to FIGS. 1 to 9.

As illustrated in FIG. 1, the radio wave propagation simulator according to the first embodiment includes a radio wave propagation analysis device 1, a storage unit 2, and a display unit 3.

The radio wave propagation analysis device 1 is a radio wave propagation analysis unit configured by a part of a computer.

The storage unit 2 includes a map information storage unit 21, an open space region information storage unit 22, and a transmission point information and reception point information storage unit 23.

The map information storage unit 21 stores map information including building information.

The map information is obtained using, for example, a geographic information system.

The map information is information for indicating a map of a two-dimensional plane obtained by viewing an urban area from above, which is an example of an outdoor environment to be analyzed for radio wave propagation. That is, the map information is two-dimensional map data indicating a two-dimensional map.

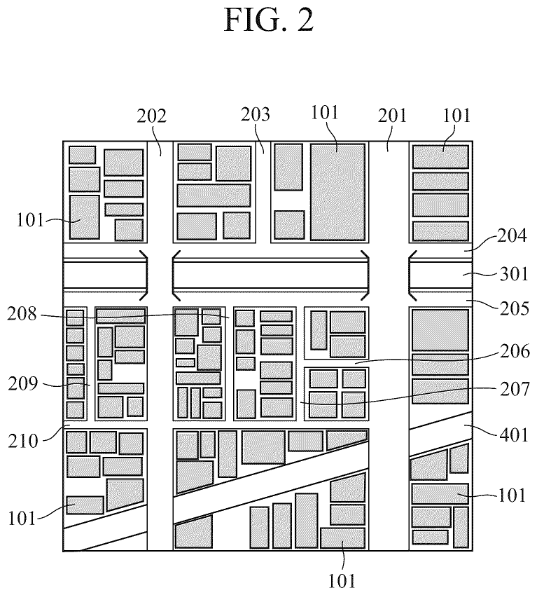

FIG. 2 illustrates an example of a map indicated by the map information.

The map illustrated as an example in FIG. 2 is represented by a large number of buildings 101, a plurality of roads 201 to 210, a river region 301, and a track region 401.

Hereinafter, the map illustrated in FIG. 2 as an example is simply referred to as a map.

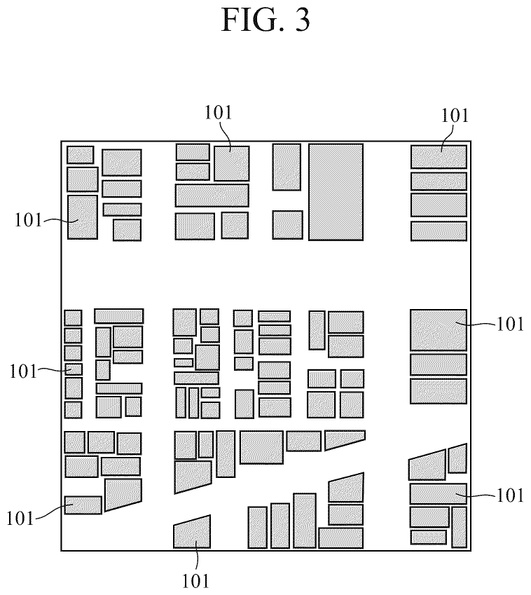

Each building 101 represents a shape of a site viewed from above, and only a large number of buildings 101 are illustrated in FIG. 3.

In each of the road 201 to the road 210, the river region 301, and the track region 401, a space is generally spread toward the sky, and in the present disclosure, the road 201 to the road 210, the river region 301, and the track region 401 are temporarily designated as open spaces, assuming that the entire sky direction is space.

The road 201 to the road 210 have a road width from one road boundary line to an opposite road boundary line, and the road 201 to the road 210 are drawn on a map with the road width.

In the river region 301, a portion between an embankment and an embankment on the opposite side is defined as a river width, and the river region 301 is drawn with the river width. However, for a river like a water channel without an embankment or a river bank, the river region 301 is drawn on the map by a range where a water flow exists.

The track is a generic term for facilities such as a roadbed and a track necessary for operation of a train, and the track region 401 has, as a generic term, a track width from one track boundary line of the track to an opposite track boundary line, and the track region 401 is drawn on a map with the track width.

The map information is constituted by digital map data that is digitized map data for representing a map, and is data associated with positions such as attribute information of positions of the buildings 101, the road 201 to the road 210, the river region 301, and the track region 401.

The open space region information storage unit 22 stores open space region information corresponding to the map information stored in the map information storage unit 21.

In the first embodiment, road information indicating the road 201 to the road 210 formed by a two-dimensional plane viewed from above is used as open space region information. The road information is two-dimensional road data indicating a two-dimensional road.

The road 201 to the road 210 indicated by the road information generally spread in space toward the sky, and can be a main propagation path of radio waves.

Therefore, in the first embodiment, radio wave propagation is analyzed assuming that the road 201 to the road 210 are main propagation paths of radio waves.

In the description of the first embodiment, in order to avoid complexity, the open space region information will be described as road information.

As the road information, for example, data created by a map production company or the like is used.

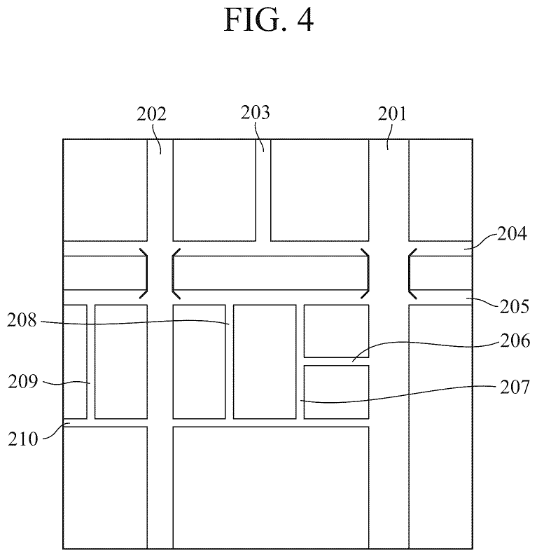

FIG. 4 illustrates an example of the roads 201 to 210 indicated only by road information.

Also in the road 201 to the road 210 illustrated in FIG. 4, the road width from one road boundary line to an opposite road boundary line is defined as a road width, and the road 201 to the road 210 are drawn on the map with the road width.

The road information is constituted by digital road data that is digitized road data for representing the road 201 to the road 210, and is data that is combined with data related to positions such as attribute information of positions with respect to the road 201 to the road 210.

The transmission point information and reception point information storage unit 23 stores position information of a transmission point and position information of a reception point installed on the map indicated by the map information stored in the map information storage unit 21.

The position information of the transmission point and the position information of the reception point are determined on the basis of the position of the transmission point and the position of the reception point assumed in the actual environment.

The determined position information of the transmission point and the determined position information of the reception point are stored in the transmission point information and reception point information storage unit 23.

Information based on the position information of the transmission point and the position information of the reception point is collectively referred to as antenna arrangement information. In addition, in a case where it is not necessary to distinguish and describe the transmission point and the reception point, it is described as an antenna.

As an example, the transmission point indicates a position of an antenna of a base station, and the reception point indicates a position of an antenna of a mobile station.

The radio wave propagation analysis device 1 includes a simplified map information generating unit 11 and a radio wave propagation analysis unit 12.

The simplified map information generating unit 11 acquires map information including building information indicating the map illustrated in FIG. 2 from the map information storage unit 21, and acquires road information corresponding to map information indicating the road 201 to the road 210 illustrated in FIG. 4 from the open space region information storage unit 22.

Hereinafter, the acquired map information and the acquired road information will be simply referred to as map information and road information in order to avoid complexity, except for a case where it is not particularly necessary to distinguish the map information and the acquired road information.

The simplified map information generating unit 11 generates block region information in which a region obtained by excluding the road 201 to the road 210 indicated by the road information from the map indicated by the map information acquired from the map information storage unit 21 is set as a block region.

In other words, the simplified map information generating unit 11 generates block region information forming a block region in a region other than the road 201 to the road 210 indicated by the road information on the map indicated by the map information.

The simplified map information generating unit 11 generates simplified map information in which the map information is simplified in which the region obtained by excluding the road 201 to the road 210 indicated by the road information on the map indicated by the map information is changed to a block region 501 indicated by the generated block region information.

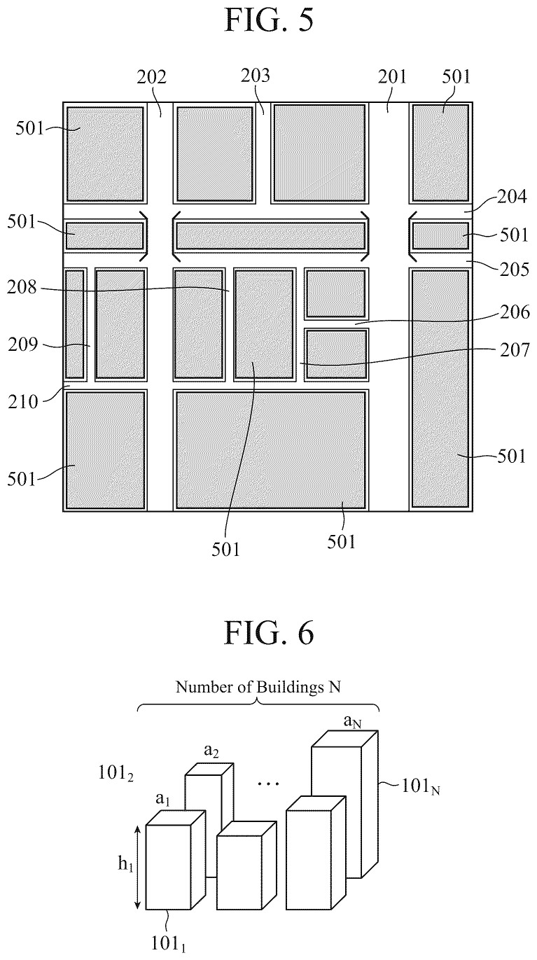

A simplified map represented by the simplified map information is illustrated in FIG. 5.

As illustrated in FIG. 5, in the region excluding the road 201 to the road 210 indicated by the road information, the river region 301 and the track region 401 is also represented as a part of the block region 501.

In addition, the simplified map information generating unit 11 may generate simplified map information obtained by simplifying the acquired map information, in which a block region is formed for each group having roads indicated by the road information acquired on the map indicated by the acquired map information as boundaries.

In this case, information having roads indicated by the road information as boundaries corresponds to block region information acquired from the acquired road information.

The block region information is digital block region data indicated as a block region having a height by preset height information by the simplified map information generating unit 11.

The preset height information may be the same height for all block regions, may be an optimum height of blocks known in advance, or a height of each block region may be set by changing the height according to the largest area of site areas existing in the block region.

Since the block region information is information having the height of the block region, the simplified map information is also information having the height with respect to the block region, and the simplified map indicated by the simplified map information indicates the three-dimensional simplified map.

The simplified map information is three-dimensional simplified map data indicating a three-dimensional simplified map.

The simplified map presented by the simplified map information is used as an analysis model to be subjected to radio wave propagation analysis by the radio wave propagation analysis unit 12.

Note that, although the map information is two-dimensional map data indicating a two-dimensional map, the map information may be three-dimensional map data indicating a three-dimensional map viewed from above.

In this case, in the simplified map information, data of the region excluding the block region is the same as the three-dimensional map data.

In addition, in a case where three-dimensional map data is used as the map information, the preset height information in the block region information is set to a height corresponding to the height of the highest building in the three-dimensional map data existing in the block region, or a median height between the height of the highest building and the height of the lowest building calculated by the simplified map information generating unit 11.

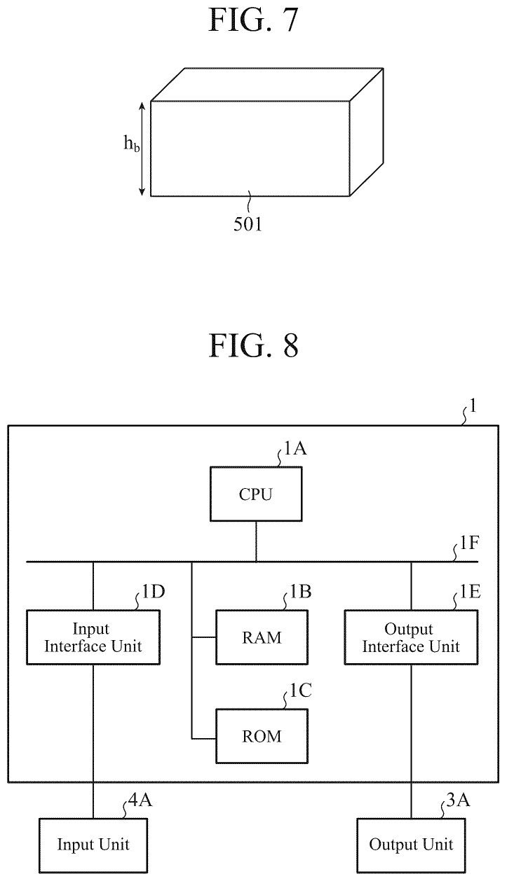

Alternatively, regarding the preset height information in the block region information for each block region, by using heights of a plurality of buildings in the three-dimensional map data existing within the specified block region, for example, according to heights hn (n is a natural number from 1 to N) of N buildings 101n (n is a natural number from 1 to N) as illustrated in FIG. 6, the simplified map information generating unit 11 may set an average value of heights of N buildings 101, existing in the block region 501 obtained by the following Expression (1) or a weighted average value obtained by adding a weighting coefficient an (n is a natural number from 1 to N) to the height hn of a plurality of buildings existing in the block region obtained by the following Expression (2) as height information indicating a preset height hb in the block region information as illustrated in FIG. 7.

$${h}_{b} = \frac{{\sum }_{n = 1}^{N} {h}_{n}}{N} \qquad ( 1 )$$

In Expression (1), hb is the height of the specified block region 501, hn is the height of each building 101n present in the specified block region 501, and Nis the number of buildings 101 present in the specified block region 501.

$${h}_{b} = \frac{{\sum }_{n = 1}^{N} {h}_{n} {a}_{n}}{{\sum }_{n = 1}^{N} {a}_{n}} \qquad ( 2 )$$

In Expression (2), an is a weighting coefficient corresponding to each building 101n existing in the specified block region 501.

The radio wave propagation analysis unit 12 performs radio wave propagation analysis on the basis of the simplified map information generated by the simplified map information generating unit 11.

The radio wave propagation analysis unit 12 acquires the simplified map information generated by the simplified map information generating unit 11, and acquires the position information of the transmission point and the position information of the reception point from the transmission point information and reception point information storage unit 23.

The radio wave propagation analysis unit 12 sets the position of the transmission point indicated by the position information of the transmission point and the position of the reception point indicated by the position information of the reception point on the simplified map indicated by the simplified map information, and analyzes a path of a radio wave from the transmission point to the reception point on the simplified map.

The radio wave propagation analysis performed by the radio wave propagation analysis unit 12 is a radio wave propagation characteristic analysis method of either ray tracing or a finite difference time domain method (FDTD method).

Note that the radio wave propagation characteristic analysis method is not limited to the ray tracing or the FDTD method, and any method may be used as long as a radio wave propagation characteristic from the transmission point to the reception point can be analyzed.

The display unit 3 receives a radio wave propagation analysis result obtained by the radio wave propagation analysis unit 12, and displays an image in which the radio wave propagation analysis result from the transmission point to the reception point is superimposed on the simplified map.

The radio wave propagation analysis device 1 is implemented by a hardware configuration with a computer, and includes a central processing unit (CPU) 1A, a large-capacity semiconductor memory (random access memory (RAM)) 1B, a storage device (read only memory (ROM)) 1C such as a nonvolatile recording device such as a hard disk device or an SSD device, an input interface unit 1D, an output interface unit 1E, and a signal path (bus) 1F as illustrated in FIG. 8.

The CPU 1A controls and manages the RAM 1B, the ROM 1C, the input interface unit 1D, and the output interface unit 1E.

The CPU 1A loads a program stored in the ROM 1C into the RAM 1B, and the CPU 1A executes various processes on the basis of the program loaded into the RAM.

A part of the storage area of the RAM 1B may constitute the storage unit 2.

The CPU 1A generates the simplified map information on the basis of the map information and the open space region information acquired from the storage unit 2 on the basis of the program loaded in the RAM, and performs the radio wave propagation analysis on the basis of the generated simplified map information and the antenna arrangement information acquired from the storage unit 2.

The CPU 1A outputs image information for obtaining an image in which the radio wave propagation analysis result from the transmission point to the reception point is superimposed on the simplified map to the display unit 3 via the output interface unit 1E.

Note that the signal path 1F is a bus that mutually connects the CPU 1A, the RAM 1B, the ROM 1C, the input interface unit 1D, and the output interface unit 1E.

Further, the output unit 3A corresponds to the display unit 3.

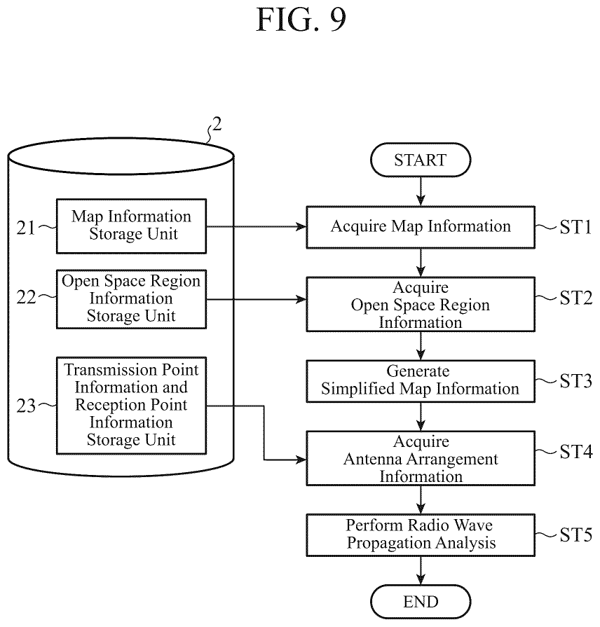

Next, an operation of the radio wave propagation analysis device 1 will be described with reference to FIG. 9.

Step ST1 is a step in which the simplified map information generating unit 11 acquires the map information from the map information storage unit 21.

Step ST2 is a step in which the simplified map information generating unit 11 acquires the road information from the open space region information storage unit 22.

Steps ST1 and ST2 constitutes an information acquisition step in which the simplified map information generating unit 11 acquires the map information and the open space region information corresponding to the map information.

Step ST3 is a simplified map generating step in which the simplified map information generating unit 11 generates block region information in which a region obtained by excluding a region indicated by the road information from a map indicated by the map information acquired in step ST1 is set as a block region, and generates simplified map information in which the map information is simplified in which the region obtained by excluding the region indicated by the road information is changed to the block region indicated by the block region information.

Step ST4 is a step in which the radio wave propagation analysis unit 12 acquires the antenna arrangement information based on the position information of the transmission point and the position information of the reception point from the transmission point information and reception point information storage unit 23.

Step ST5 is a step in which the radio wave propagation analysis unit 12 sets the position of the antenna indicated by the antenna arrangement information on the simplified map indicated by the simplified map information generated in step ST3, and performs radio wave propagation analysis by the radio wave propagation characteristic analysis method.

Steps ST4 and ST5 constitute an analysis step in which the radio wave propagation analysis unit 12 performs radio wave propagation analysis on the basis of the simplified map information.

In this manner, the radio wave propagation analysis device 1 executes radio wave propagation analysis and generates image information for displaying an image in which the radio wave propagation analysis result from the transmission point to the reception point is superimposed on the simplified map.

The radio wave propagation analysis method in steps ST1 to ST5 is performed by the CPU 1A executing processing according to a program stored in the ROM.

That is, the program stored in the ROM includes an information acquisition procedure of acquiring map information including building information and road information which is open space region information corresponding to the map information, a simplified map generation procedure of generating block region information in which a region obtained by excluding a road indicated by the road information from a map indicated by the map information is set as a block region and generating simplified map information in which the map information is simplified in which the region obtained by excluding the road indicated by the road information is changed to the block region indicated by the block region information, and a radio wave propagation analysis procedure of performing radio wave propagation analysis on the basis of the simplified map information.

As described above, the radio wave propagation analysis device 1 in the radio wave propagation simulator according to the first embodiment includes the simplified map information generating unit 11 that generates block region information in which a region obtained by excluding a road indicated by road information which is open space region information from a map indicated by map information including building information is set as a block region, and generates simplified map information in which the map information is simplified in which the region obtained by excluding the road 201 to the road 210 indicated by the road information is changed to the block region 501 indicated by the block region information, and the radio wave propagation analysis unit 12 that performs radio wave propagation analysis on the basis of the simplified map information, in which the radio wave propagation analysis is performed on the basis of the simplified map information in which a region other than the road 201 to the road 210 that can be a main propagation path of radio waves is set as the block region 501, so that it is possible to remove a factor that causes degradation of analysis accuracy as much as possible, and reduce an amount of calculation required for radio wave propagation analysis, thereby accelerating calculation processing.

### Second Embodiment

A radio wave propagation simulator including a radio wave propagation analysis device 1 according to a second embodiment will be described with reference to FIGS. 1 to 4 and FIGS. 6 to 11.

The radio wave propagation simulator according to the second embodiment is different from the radio wave propagation simulator according to the first embodiment in that river region information is added as open space region information, and the other points are the same.

The river region 301 indicated by the river region information generally has a space extending toward the sky, and can be a main propagation path of radio waves.

The radio wave propagation simulator according to the second embodiment includes the radio wave propagation analysis device 1 including the simplified map information generating unit 11 and the radio wave propagation analysis unit 12, the storage unit 2 including the map information storage unit 21, the open space region information storage unit 22, and the transmission point information and reception point information storage unit 23, and the display unit 3.

Hereinafter, differences from the radio wave propagation simulator according to the first embodiment will be mainly described.

In the second embodiment, road information indicating the road 201 to the road 210 formed by a two-dimensional plane viewed from above and river region information indicating the river region 301 are used as open space region information.

The road information is the same as the road information described in the first embodiment.

The river region information is two-dimensional river region data indicating a two-dimensional river region.

Therefore, in the second embodiment, radio wave propagation is analyzed assuming that the road 201 to the road 210 and the river region 301 are main propagation paths of radio waves.

As the river region information, for example, data extracted from digital elevation data of the Geospatial Information Authority of Japan or the like is used.

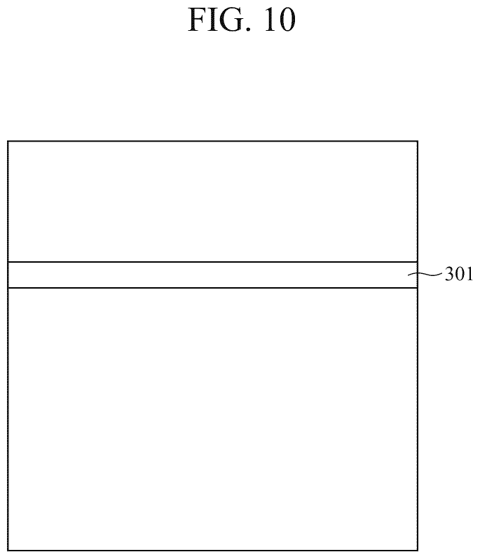

FIG. 10 illustrates an example indicating the river region 301 indicated only by the river region information.

Also in the river region 301 illustrated in FIG. 10, a portion between an embankment and an embankment on the opposite side is defined as a river width, and for a river like a water channel without an embankment or a river bank, a range where a water flow exists is defined as a river width, and the river region 301 is drawn on a map with the river width.

The river region information is constituted by digital river region data that is digitized river region data for representing the river region 301, and is data associated with a position such as attribute information of the position of the river region 301.

The open space region information storage unit 22 stores road information and river region information, which are open space region information corresponding to the map information stored in the map information storage unit 21.

The map information storage unit 21 and the transmission point information and reception point information storage unit 23 are the same as the map information storage unit 21 and the transmission point information and reception point information storage unit 23 in the first embodiment.

The simplified map information generating unit 11 acquires map information including building information indicating the map illustrated in FIG. 2 from the map information storage unit 21, and acquires road information indicating the road 201 to the road 210 illustrated in FIG. 4 and river region information indicating the river region 301 illustrated in FIG. 10 corresponding to the map information from the open space region information storage unit 22 as open space region information.

The simplified map information generating unit 11 generates block region information in which a region obtained by excluding the road 201 to the road 210 and the river region 301 indicated by open space region information including the road information and the river region information from the map indicated by the map information acquired from the map information storage unit 21 is set as the block region 501.

The simplified map information generating unit 11 generates simplified map information in which the map information is simplified in which the region obtained by excluding the road 201 to the road 210 and the river region 301 indicated by the open space region information on the map indicated by the map information is changed to the block region 501 indicated by the block region information.

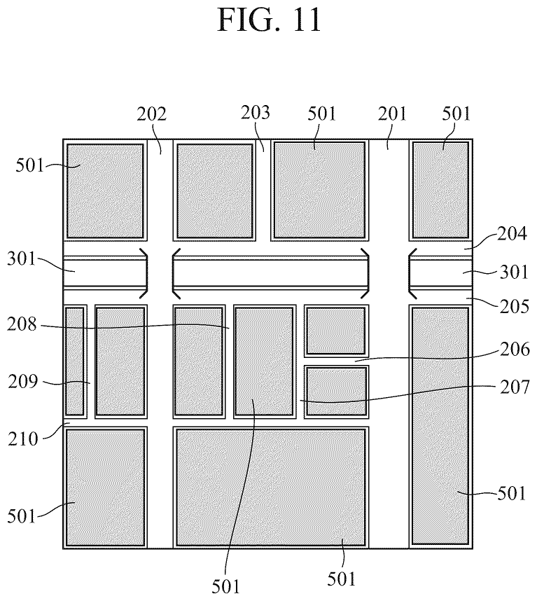

A simplified map represented by the simplified map information is illustrated in FIG. 11.

As illustrated in FIG. 11, in the region obtained by excluding the road 201 to the road 210 indicated by the road information and the river region 301 indicated by the river region information, the track region 401 is also represented as a part of the block region 501.

The radio wave propagation analysis unit 12 and the display unit 3 operate in the same manner as the radio wave propagation analysis unit 12 and the display unit 3 in the first embodiment.

Similarly to the radio wave propagation analysis device 1 according to the first embodiment, the radio wave propagation analysis device 1 is implemented by a hardware configuration by a computer illustrated in FIG. 8.

The operation of the radio wave propagation analysis device 1 is also similar to the operation illustrated in FIG. 9 in the radio wave propagation analysis device 1 according to the first embodiment, and is different in that the river region information is added as open space region information.

Hereinafter, differences will be mainly described.

Step ST1 is the same as step ST1 in the first embodiment.

Step ST2 is a step in which the simplified map information generating unit 11 acquires the road information and the river region information from the open space region information storage unit 22 as open space region information.

In step ST3, the simplified map information generating unit 11 generates block region information in which a region obtained by excluding the road 201 to the road 210 and the river region 301 indicated by the open space region information including the road information and the river region information from the map indicated by the map information acquired in step ST2 is set as the block region 501.

Further, in step ST3, the simplified map information generating unit 11 generates simplified map information in which the map information is simplified in which the region obtained by excluding the road 201 to the road 210 and the river region 301 indicated by the open space region information including the road information and the river region information is changed to the block region 501 indicated by the block region information.

Step ST3 is a simplified map generating step.

Steps ST4 and ST5 are the same as steps ST4 and ST5 in the first embodiment.

In this manner, the radio wave propagation analysis device 1 executes radio wave propagation analysis and generates image information for displaying an image in which a radio wave propagation analysis result from the transmission point to the reception point is superimposed on the simplified map.

The radio wave propagation analysis method in steps ST1 to ST5 is performed by the CPU 1A executing processing according to a program stored in the ROM.

That is, the program stored in the ROM includes an information acquisition procedure of acquiring map information including building information and road information and river region information, which are open space region information corresponding to the map information, a simplified map generation procedure of generating block region information in which a region obtained by excluding a road and a river region indicated by the road information and the river region information from a map indicated by the map information is set as a block region, and generating simplified map information in which the map information is simplified in which the region obtained by excluding the road and the river region indicated by the road information and the river region information is changed to the block region indicated by the block region information, and a radio wave propagation analysis procedure of performing radio wave propagation analysis on the basis of the simplified map information.

As described above, the radio wave propagation analysis device 1 in the radio wave propagation simulator according to the second embodiment includes the simplified map information generating unit 11 that generates block region information in which a region obtained by excluding the road 201 to the road 210 indicated by the road information and the river region 301 indicated by the river region information, which are open space region information, from a map indicated by map information including building information is set as the block region 501, and generates simplified map information in which the map information is simplified in which the region obtained by excluding the road 201 to the road 210 indicated by the road information and the river region 301 indicated by the river region information is changed to the block region 501 indicated by the block region information, and the radio wave propagation analysis unit 12 that performs radio wave propagation analysis on the basis of the simplified map information, in which the radio wave propagation analysis is performed on the basis of the simplified map information in which a region other than the road 201 to the road 210 and the river region 301 that can be a main propagation path of radio waves is set as the block region 501, so that it is possible to use a simplified map closer to an actual urban area structure, remove a factor that causes degradation of analysis accuracy as much as possible, and reduce an amount of calculation required for radio wave propagation analysis, thereby accelerating calculation processing.

Note that the radio wave propagation analysis device 1 in the radio wave propagation simulator according to the second embodiment is configured so that the river region information is added to the road information as open space region information, but the river region information alone may be the open space region information.

### Third Embodiment

A radio wave propagation simulator including a radio wave propagation analysis device 1 according to a third embodiment will be described with reference to FIGS. 1 to 4, 6 to 9, 9, 12, and 13.

The radio wave propagation simulator according to the third embodiment is different from the radio wave propagation simulator according to the first embodiment in that track region information is added as open space region information, and the other points are the same.

The track region 401 indicated by the track region information generally has a space extending toward the sky, and can be a main propagation path of radio waves.

The radio wave propagation simulator according to the third embodiment includes the radio wave propagation analysis device 1 including the simplified map information generating unit 11 and the radio wave propagation analysis unit 12, the storage unit 2 including the map information storage unit 21, the open space region information storage unit 22, and the transmission point information and reception point information storage unit 23, and the display unit 3.

Hereinafter, differences from the radio wave propagation simulator according to the first embodiment will be mainly described.

In the third embodiment, road information indicating the road 201 to the road 210 formed by a two-dimensional plane viewed from above and track region information indicating the track region 401 are used as open space region information.

The road information is the same as the road information described in the first embodiment.

The track region information is two-dimensional track region data indicating a two-dimensional track region.

Therefore, in the third embodiment, radio wave propagation is analyzed assuming that the road 201 to the road 210 and the track region 401 are main propagation paths of radio waves.

As the track region information, for example, data created by a map production company or the like is used.

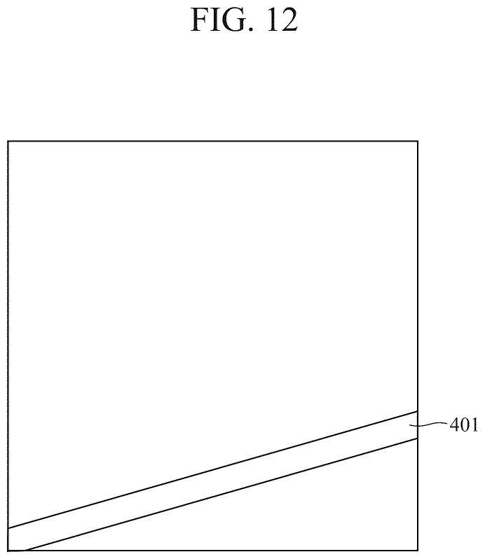

FIG. 12 illustrates an example illustrating the track region 401 indicated only by the track region information.

Also in the track region 401 illustrated in FIG. 12, a track width from one track boundary line to an opposite track boundary line of the track is defined as a track width, and the track region 401 is drawn on a map with the track width.

The track region information is constituted by digital track region data that is digitized track region data for representing the track region 401, and is data associated with a position such as attribute information of the position for the track region 401.

The open space region information storage unit 22 stores road information and track region information, which are open space region information corresponding to the map information stored in the map information storage unit 21.

The map information storage unit 21 and the transmission point information and reception point information storage unit 23 are the same as the map information storage unit 21 and the transmission point information and reception point information storage unit 23 in the first embodiment.

The simplified map information generating unit 11 acquires map information including building information indicating the map illustrated in FIG. 2 from the map information storage unit 21, and acquires road information indicating the road 201 to the road 210 illustrated in FIG. 4 and track region information indicating the track region 401 illustrated in FIG. 12 corresponding to the map information from the open space region information storage unit 22 as open space region information.

The simplified map information generating unit 11 generates block region information in which a region obtained by excluding the road 201 to the road 210 and the track region 401 indicated by open space region information including the road information and the track region information from the map indicated by the map information acquired from the map information storage unit 21 is set as the block region 501.

The simplified map information generating unit 11 generates simplified map information in which the map information is simplified in which the region obtained by excluding the road 201 to the road 210 and the track region 401 indicated by the open space region information on the map indicated by the map information is changed to the block region 501 indicated by the block region information.

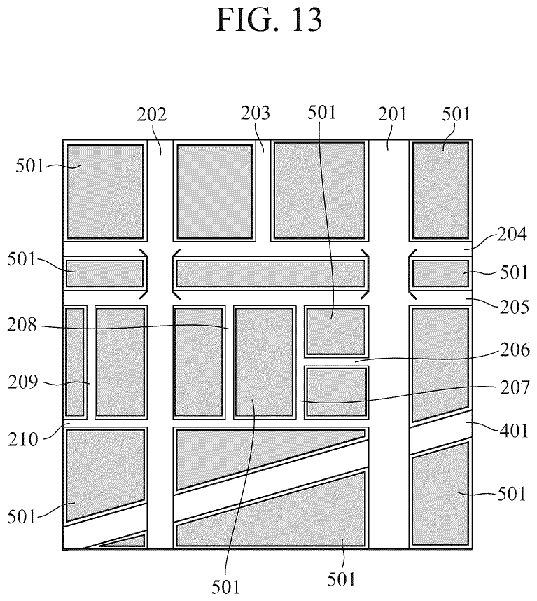

A simplified map represented by the simplified map information is illustrated in FIG. 13.

As illustrated in FIG. 13, in the region obtained by excluding the road 201 to the road 210 indicated by the road information and the track region 401 indicated by the track region information, the river region 301 is also represented as a part of the block region 501.

The radio wave propagation analysis unit 12 and the display unit 3 operate in the same manner as the radio wave propagation analysis unit 12 and the display unit 3 in the first embodiment.

Similarly to the radio wave propagation analysis device 1 according to the first embodiment, the radio wave propagation analysis device 1 is implemented by a hardware configuration by the computer illustrated in FIG. 8.

The operation of the radio wave propagation analysis device 1 is also similar to the operation illustrated in FIG. 9 in the radio wave propagation analysis device 1 according to the first embodiment, and is different in that the track region information is added as open space region information.

Hereinafter, differences will be mainly described.

Step ST1 is the same as step ST1 in the first embodiment.

Step ST2 is a step in which the simplified map information generating unit 11 acquires the road information and the track region information from the open space region information storage unit 22 as open space region information.

In step ST3, the simplified map information generating unit 11 generates block region information in which a region obtained by excluding the road 201 to the road 210 and the track region 401 indicated by the open space region information including the road information and the track region information from the map indicated by the map information acquired in step ST2 is set as the block region 501.

Further, in step ST3, the simplified map information generating unit 11 generates simplified map information in which the map information is simplified in which the region obtained by excluding the road 201 to the road 210 and the track region 401 indicated by the open space region information including the road information and the track region information is changed to the block region 501 indicated by the block region information.

Step ST3 is a simplified map generating step.

Steps ST4 and ST5 are the same as steps ST4 and ST5 in the first embodiment.

In this manner, the radio wave propagation analysis device 1 executes radio wave propagation analysis and generates image information for displaying an image in which a radio wave propagation analysis result from the transmission point to the reception point is superimposed on the simplified map.

The radio wave propagation analysis method in steps ST1 to ST5 is performed by the CPU 1A executing processing according to a program stored in the ROM.

That is, the program stored in the ROM includes an information acquisition procedure of acquiring map information including building information and road information and track region information, which are open space region information corresponding to the map information, a simplified map generation procedure of generating block region information in which a region obtained by excluding a road and a track region indicated by the road information and the track region information from a map indicated by the map information is set as a block region, and generating simplified map information in which the map information is simplified in which the region obtained by excluding the road and the track region indicated by the road information and the track region information is changed to the block region indicated by the block region information, and a radio wave propagation analysis procedure of performing radio wave propagation analysis on the basis of the simplified map information.

As described above, the radio wave propagation analysis device 1 in the radio wave propagation simulator according to the third embodiment includes the simplified map information generating unit 11 that generates block region information in which a region obtained by excluding the road 201 to the road 210 indicated by the road information and the track region 401 indicated by the track region information, which are open space region information, from a map indicated by map information including building information is set as the block region 501, and generates simplified map information in which the map information is simplified in which the region obtained by excluding the road 201 to the road 210 indicated by the road information and the track region 401 indicated by the track region information is changed to the block region 501 indicated by the block region information, and the radio wave propagation analysis unit 12 that performs radio wave propagation analysis on the basis of the simplified map information, in which the radio wave propagation analysis is performed on the basis of the simplified map information in which a region other than the road 201 to the road 210 and the track region 401 that can be a main propagation path of radio waves is set as the block region, so that it is possible to use a simplified map closer to an actual urban area structure, remove a factor that causes degradation of analysis accuracy as much as possible, and reduce a calculation amount required for radio wave propagation analysis, thereby accelerating calculation processing.

Note that the radio wave propagation analysis device 1 in the radio wave propagation simulator according to the third embodiment is configured so that the track region information is added to the road information as open space region information, but the track region information alone may be the open space region information.

### Fourth Embodiment

A radio wave propagation simulator including a radio wave propagation analysis device 1 according to a fourth embodiment will be described with reference to FIGS. 1 to 4, 6 to 10, 12, and 14.

The radio wave propagation simulator according to the fourth embodiment is different from the radio wave propagation simulator according to the first embodiment in that river region information and track region information are added as open space region information, and the other points are the same.

In other words, the radio wave propagation simulator according to the fourth embodiment is different from the radio wave propagation simulator according to the second embodiment in that the track region information is added as open space region information, or is different from the radio wave propagation simulator according to the third embodiment in that the river region information is added as open space region information, and the other points are the same.

The radio wave propagation simulator according to the fourth embodiment includes the radio wave propagation analysis device 1 including the simplified map information generating unit 11 and the radio wave propagation analysis unit 12, the storage unit 2 including the map information storage unit 21, the open space region information storage unit 22, and the transmission point information and reception point information storage unit 23, and the display unit 3.

Hereinafter, differences from the radio wave propagation simulator according to the first embodiment will be mainly described.

In the fourth embodiment, road information indicating the road 201 to the road 210, river region information indicating the river region 301, and track region information indicating the track region 401 are used as open space region information.

The road information is the same as the road information described in the first embodiment, the river region information is the same as the river region information described in the second embodiment, and the track region information is the same as the track region information described in the third embodiment.

Therefore, in the fourth embodiment, the road 201 to the road 210, the river region 301, and the track region 401 are assumed as main propagation paths of radio waves, and radio wave propagation is analyzed.

The open space region information storage unit 22 stores road information, river region information, and track region information, which are open space region information corresponding to the map information stored in the map information storage unit 21.

The map information storage unit 21 and the transmission point information and reception point information storage unit 23 are the same as the map information storage unit 21 and the transmission point information and reception point information storage unit 23 in the first embodiment.

The simplified map information generating unit 11 acquires map information including building information indicating the map illustrated in FIG. 2 from the map information storage unit 21, and acquires road information indicating the road 201 to the road 210 illustrated in FIG. 4, river region information indicating the river region 301 illustrated in FIG. 10, and track region information indicating the track region 401 illustrated in FIG. 12 corresponding to the map information from the open space region information storage unit 22 as open space region information.

The simplified map information generating unit 11 generates block region information in which a region obtained by excluding the road 201 to the road 210, the river region 301, and the track region 401 indicated by open space region information including the road information, the river region information, and the track region information from the map indicated by the map information acquired from the map information storage unit 21 is set as the block region 501.

The simplified map information generating unit 11 generates simplified map information in which the map information is simplified in which the region obtained by excluding the road 201 to the road 210, the river region 301, and the track region 401 indicated by the open space region information on the map indicated by the map information is changed to the block region 501 indicated by the block region information.

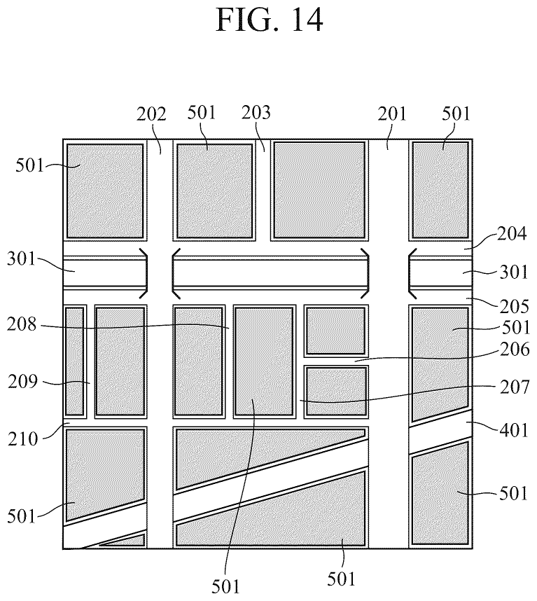

A simplified map represented by the simplified map information is illustrated in FIG. 14.

The radio wave propagation analysis unit 12 and the display unit 3 operate in the same manner as the radio wave propagation analysis unit 12 and the display unit 3 in the first embodiment.

Similarly to the radio wave propagation analysis device 1 according to the first embodiment, the radio wave propagation analysis device 1 is implemented by a hardware configuration by the computer illustrated in FIG. 8.

The operation of the radio wave propagation analysis device 1 is also similar to the operation illustrated in FIG. 9 in the radio wave propagation analysis device 1 according to the first embodiment, and is different in that the river region information and the track region information are added as open space region information.

Hereinafter, differences will be mainly described.

Step ST1 is the same as step ST1 in the first embodiment.

Step ST2 is a step in which the simplified map information generating unit 11 acquires the road information, the river region information, and the track region information from the open space region information storage unit 22 as open space region information.

In step ST3, the simplified map information generating unit 11 generates block region information in which a region obtained by excluding the road 201 to the road 210, the river region 301, and the track region 401 indicated by the open space region information including the road information, the river region information, and the track region information from the map indicated by the map information acquired in step ST2 is set as the block region 501.

Further, in step ST3, the simplified map information generating unit 11 generates simplified map information in which the map information is simplified in which the region obtained by excluding the road 201 to the road 210, the river region 301, and the track region 401 indicated by the open space region information including the road information, the river region information, and the track region information is changed to the block region 501 indicated by the block region information.

Step ST3 is a simplified map generating step.

Steps ST4 and ST5 are the same as steps ST4 and ST5 in the first embodiment.

In this manner, the radio wave propagation analysis device 1 executes radio wave propagation analysis and generates image information for displaying an image in which a radio wave propagation analysis result from the transmission point to the reception point is superimposed on the simplified map.

The radio wave propagation analysis method in steps ST1 to ST5 is performed by the CPU 1A executing processing according to a program stored in the ROM.

That is, the program stored in the ROM includes an information acquisition procedure of acquiring map information including building information and road information, river region information, and track region information, which are open space region information corresponding to the map information, a simplified map generation procedure of generating block region information in which a region obtained by excluding a road, a river region, and a track region indicated by the road information, the river region information, and the track region information from a map indicated by the map information is set as a block region, and generating simplified map information in which the map information is simplified in which the region obtained by excluding the road, the river region, and the track region indicated by the road information, the river region information, and the track region information is changed to the block region indicated by the block region information, and a radio wave propagation analysis procedure of performing radio wave propagation analysis on the basis of the simplified map information.

As described above, the radio wave propagation analysis device 1 in the radio wave propagation simulator according to the fourth embodiment includes the simplified map information generating unit 11 that generates block region information in which a region obtained by excluding the road 201 to the road 210 indicated by the road information, the river region 301 indicated by the river region information, and the track region 401 indicated by the track region information, which are open space region information, from a map indicated by map information including building information is set as the block region 501, and generates simplified map information in which the map information is simplified in which the region obtained by excluding the road 201 to the road 210 indicated by the road information, the river region 301 indicated by the river region information, and the track region 401 indicated by the track region information is changed to the block region 501 indicated by the block region information, and the radio wave propagation analysis unit 12 that performs radio wave propagation analysis on the basis of the simplified map information, in which the radio wave propagation analysis is performed on the basis of the simplified map information in which a region other than the road 201 to the road 210, the river region 301, and the track region 401 that can be a main propagation path of radio waves is set as the block region, so that it is possible to use a simplified map closer to an actual urban area structure, remove a factor that causes degradation of analysis accuracy as much as possible, and reduce a calculation amount required for radio wave propagation analysis, thereby accelerating calculation processing.

Note that the radio wave propagation analysis device 1 in the radio wave propagation simulator according to the fourth embodiment is configured so that the river region information and the track region information are added to the road information as open space region information, but the river region information and the track region information may be the open space region information.

### Fifth Embodiment

A radio wave propagation simulator including a radio wave propagation analysis device 1 according to a fifth embodiment will be described with reference to FIGS. 15, 2 to 4, 6 to 8, 10, 12, 16, and 17.

The radio wave propagation simulator according to the fifth embodiment is different from the radio wave propagation simulator according to the fourth embodiment in that the radio wave propagation simulator further includes an open space region information setting unit 13 that sets open space region information acquired by the simplified map information generating unit 11, and the other points are the same.

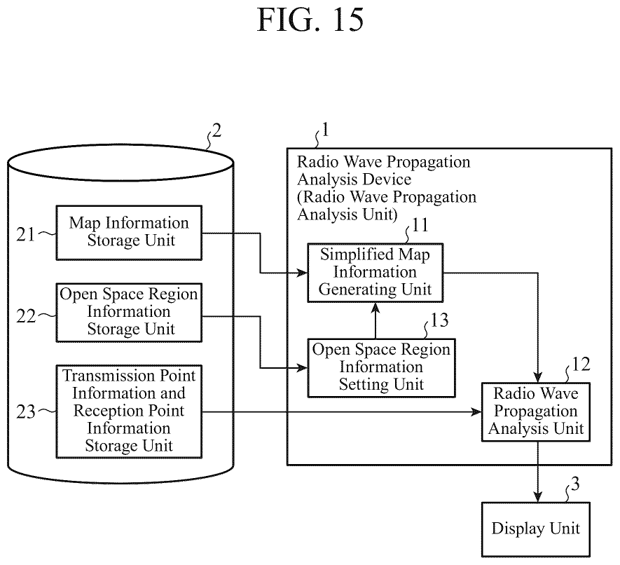

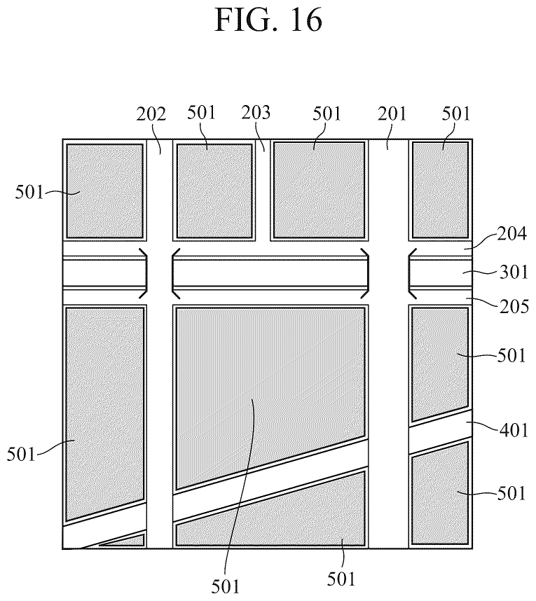

As illustrated in FIG. 15, the radio wave propagation simulator according to the fifth embodiment includes the radio wave propagation analysis device 1 including the simplified map information generating unit 11, the radio wave propagation analysis unit 12, and the open space region information setting unit 13, the storage unit 2 including the map information storage unit 21, the open space region information storage unit 22, and the transmission point information and reception point information storage unit 23, and the display unit 3.

Hereinafter, differences from the radio wave propagation simulator according to the fourth embodiment will be mainly described.

The map information storage unit 21, the open space region information storage unit 22, and the transmission point information and reception point information storage unit 23 are the same as the map information storage unit 21, the open space region information storage unit 22, and the transmission point information and reception point information storage unit 23 in the fourth embodiment.

The open space region information setting unit 13 acquires, from the open space region information storage unit 22, road information indicating the road 201 to the road 210 illustrated in FIG. 4 corresponding to map information indicating the map illustrated in FIG. 2.

The open space region information setting unit 13 classifies the road information into a plurality of pieces of road information according to the road width indicated by the road information.

For example, in FIG. 4, the open space region information setting unit 13 classifies the road 201 to the road 210 indicated by the road information into road information indicating four types of roads: the road 201 having the largest road width, the road 202 having the second largest road width, the road 203 to the road 205 having the third largest road width, and the road 206 to the road 210 having the narrowest road width according to the road width indicated by the road information.

The open space region information setting unit 13 sets, as the open space region information, road information indicating the road 201 to the road 205 excluding road information indicating the road 206 to the road 210 classified as the narrowest road width.

The simplified map information generating unit 11 acquires map information including building information indicating the map illustrated in FIG. 2 from the map information storage unit 21, acquires the road information indicating the road 201 to the road 205 set by the open space region information setting unit 13 as open space region information, and acquires river region information indicating the river region 301 illustrated in FIG. 10 and track region information indicating the track region 401 illustrated in FIG. 12 corresponding to the map information as open space region information from the open space region information storage unit 22.

Therefore, in the fifth embodiment, the road 201 to the road 205, the river region 301, and the track region 401 are assumed as main propagation paths of radio waves, and radio wave propagation is analyzed.

The simplified map information generating unit 11 generates block region information in which a region obtained by excluding the road 201 to the road 205 indicated by the road information, the river region 301 indicated by the river region information, and the track region 401 indicated by the track region information from the map indicated by the map information acquired from the map information storage unit 21 is set as the block region 501.

The simplified map information generating unit 11 generates simplified map information in which the map information is simplified in which the region obtained by excluding the road 201 to the road 205, the river region 301, and the track region 401 indicated by the open space region information on the map indicated by the map information is changed to the block region 501 indicated by the block region information.

A simplified map represented by the simplified map information is illustrated in FIG. 16.

As illustrated in FIG. 16, in the region obtained by excluding the road 201 to the road 205 indicated by the road information, the river region 301 indicated by the river region information, and the track region 401 indicated by the track region information, the road 206 to the road 210 indicated by the road information is also represented as a part of the block region 501.

Since the narrowest roads considered to be unnecessary as main propagation paths of the radio wave based on the road width are deleted from the simplified map, the simplified map can be further simplified, and the amount of calculation required for radio wave propagation analysis can be reduced.

The radio wave propagation analysis unit 12 and the display unit 3 operate in the same manner as the radio wave propagation analysis unit 12 and the display unit 3 in the fourth embodiment.

Similarly to the radio wave propagation analysis device 1 according to the fourth embodiment, the radio wave propagation analysis device 1 is implemented by a hardware configuration by the computer illustrated in FIG. 8.

The operation of the radio wave propagation analysis device 1 is also similar to the operation of the radio wave propagation analysis device 1 according to the fourth embodiment, and is different in that step ST2A of setting road information that is open space region information is added.

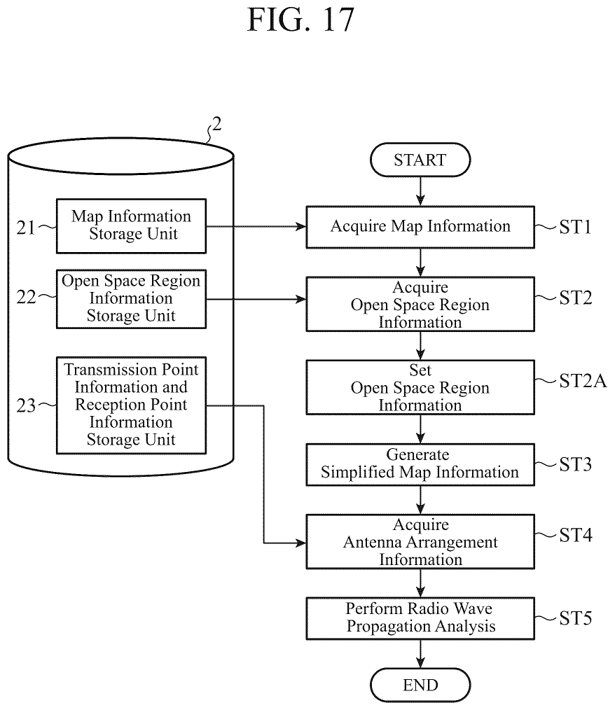

Hereinafter, differences will be mainly described with reference to FIG. 17.

Step ST1 is the same as step ST1 in the first embodiment.

Step ST2 is a step in which the open space region information setting unit 13 acquires the road information from the open space region information storage unit 22, and the simplified map information generating unit 11 acquires the river region information and the track region information from the open space region information storage unit 22 as the open space region information.

Step ST2A is a step in which the open space region information setting unit 13 classifies the road information into a plurality of pieces of road information according to the road width indicated by the road information, and sets the road information indicating the road 201 to the road 205 excluding the road information indicating the road 206 to the road 210 classified as the narrowest road width as the open space region information.

In step ST3, the simplified map information generating unit 11 generates block region information in which a region obtained by excluding the road 201 to the road 205 indicated by the road information set in step ST2A and the river region 301 and the track region 401 indicated by the river region information and the track region information acquired in step ST2 from the map indicated by the map information acquired in step ST2 is set as the block region 501.

Further, in step ST3, the simplified map information generating unit 11 generates simplified map information in which the map information is simplified in which the region obtained by excluding the road 201 to the road 205, the river region 301, and the track region 401 indicated by the open space region information including the road information, the river region information, and the track region information is changed to the block region 501 indicated by the block region information.

Step ST3 is a simplified map generating step.

Steps ST4 and ST5 are the same as steps ST4 and ST5 in the fourth embodiment.

In this manner, the radio wave propagation analysis device 1 executes radio wave propagation analysis and generates image information for displaying an image in which a radio wave propagation analysis result from the transmission point to the reception point is superimposed on the simplified map.

The radio wave propagation analysis method in steps ST1 to ST5 is performed by the CPU 1A executing processing according to a program stored in the ROM.

That is, the program stored in the ROM includes an information acquisition procedure of acquiring map information including building information and road information, river region information, and track region information corresponding to the map information, a procedure of classifying the acquired road information into a plurality of pieces of road information according to a road width and setting road information excluding road information classified as a narrowest road width as open space region information, a simplified map generation procedure of generating block region information in which a region obtained by excluding a road indicated by the road information set as the open space region information and a river region and a track region indicated by the river region information and the track region information acquired as open space region information from a map indicated by the map information is set as a block region, and generating simplified map information in which the map information is simplified in which the region obtained by excluding the road indicated by set road information, and the river region and the track region indicated by the acquired river region information and track region information is changed to the block region indicated by block region information, and a radio wave propagation analysis procedure of performing radio wave propagation analysis on the basis of the simplified map information.

As described above, the radio wave propagation analysis device 1 in the radio wave propagation simulator according to the fifth embodiment includes the open space region information setting unit that classifies road information into a plurality of pieces of road information according to a road width indicated by the road information, and sets road information excluding road information classified as a narrowest road width as open space region information, the simplified map information generating unit 11 that generates block region information in which a region obtained by excluding the road 201 to the road 205 indicated by the road information which is the set open space region information, and the river region 301 indicated by the river region information and the track region 401 indicated by the track region information which are open space region information from a map indicated by map information including building information is set as the block region 501, and generates simplified map information in which the map information is simplified in which the region obtained by excluding the road 201 to the road 205 indicated by the set road information, the river region 301 indicated by the river region information, and the track region 401 indicated by the track region information is changed to the block region 501 indicated by the block region information, and the radio wave propagation analysis unit 12 that performs radio wave propagation analysis on the basis of the simplified map information, in which the radio wave propagation analysis is performed on the basis of the simplified map information in which a region other than the road 201 to the road 210, the river region 301, and the track region 401 that can be a main propagation path of radio waves is set as the block region, so that it is possible to use a simplified map closer to an actual urban area structure, remove a factor that causes degradation of analysis accuracy as much as possible, and further reduce a calculation amount required for radio wave propagation analysis, thereby accelerating calculation processing.

Note that the open space region information setting unit 13 of the radio wave propagation analysis device 1 in the radio wave propagation simulator according to the fifth embodiment sets the road information to a target as the open space region information, but may set the river region information or the track region information to a target as the open space region information.

That is, in a case where the river region information is included as the open space region information, the open space region information setting unit 13 classifies the river region information into a plurality of pieces of river region information according to the river region width, and sets river region information by excluding river region information classified as a smallest river region width as open space region information, and thus the river region information, which is the open space region information acquired by the simplified map information generating unit 11, is river region information set by excluding the river region information classified as the smallest river region width by the open space region information setting unit 13.

In a case where the track region information is included as the open space region information, the open space region information setting unit 13 classifies the track region information into a plurality of pieces of track region information according to the track region width, and sets track region information by excluding track region information classified as a smallest track region width as open space region information, and thus the track region information, which is the open space region information acquired by the simplified map information generating unit 11, is track region information set by excluding the track region information classified as the smallest track region width by the open space region information setting unit 13.

In addition, the radio wave propagation analysis device 1 in the radio wave propagation simulator according to the fifth embodiment is such that the open space region information setting unit 13 is further included in the radio wave propagation analysis device 1 in the radio wave propagation simulator according to the fourth embodiment, but the open space region information setting unit 13 may be further included in the radio wave propagation analysis device 1 in the radio wave propagation simulator according to the first embodiment, the open space region information setting unit 13 may be further included in the radio wave propagation analysis device 1 in the radio wave propagation simulator according to the second embodiment, or the open space region information setting unit 13 may be further included in the radio wave propagation analysis device 1 in the radio wave propagation simulator according to the third embodiment.

### Sixth Embodiment

A radio wave propagation simulator including a radio wave propagation analysis device 1 according to a sixth embodiment will be described with reference to FIGS. 18, 2 to 4, 6 to 8, 10, 12, 17, and 19.

The radio wave propagation simulator according to the sixth embodiment is different from the radio wave propagation simulator according to the fifth embodiment in that additional open space region information input from an additional open space region information input unit 4 is added as open space region information, and the other points are the same.

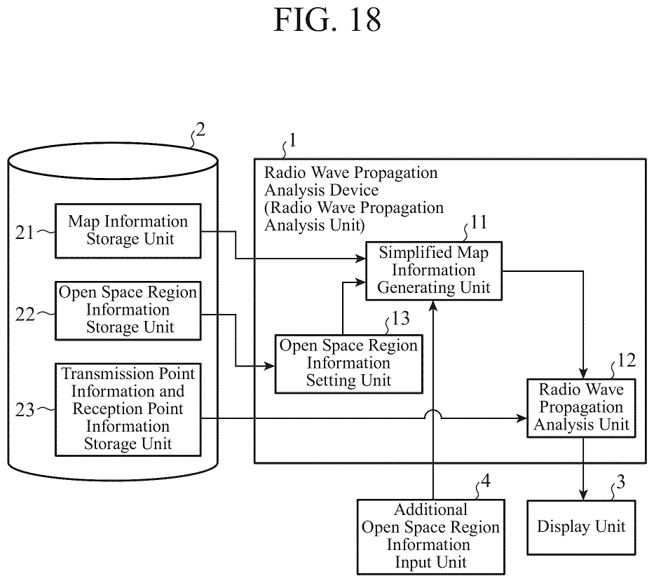

As illustrated in FIG. 18, the radio wave propagation simulator according to the sixth embodiment includes the radio wave propagation analysis device 1 including the simplified map information generating unit 11, the radio wave propagation analysis unit 12, and the open space region information setting unit 13, the storage unit 2 including the map information storage unit 21, the open space region information storage unit 22, a transmission point information and reception point information storage unit 23, the display unit 3, and the additional open space region information input unit 4.

Hereinafter, differences from the radio wave propagation simulator according to the fifth embodiment will be mainly described.

The map information storage unit 21, the open space region information storage unit 22, and the transmission point information and reception point information storage unit 23 are the same as the map information storage unit 21, the open space region information storage unit 22, and the transmission point information and reception point information storage unit 23 in the fifth embodiment.

Further, the open space region information setting unit 13 is also the same as the open space region information setting unit 13 according to the fifth embodiment.

In a case where, as the road information that is open space region information stored in the open space region information storage unit 22, for example, data created by a map production company or the like is used, a road 211 may actually exist other than the road 201 to the road 210 indicated by the road information stored in the open space region information storage unit 22 within the range of the map indicated by the map information stored in the map information storage unit 21.

The radio wave propagation simulator according to the sixth embodiment analyzes radio wave propagation by assuming the road 211 that is not stored in the open space region information storage unit 22 but actually exists as a main propagation path.

That is, the radio wave propagation simulator according to the sixth embodiment analyzes the radio wave propagation by assuming the road 201 to the road 205 indicated by the road information stored in the open space region information storage unit 22 and set as the open space region information by the open space region information setting unit 13, the river region 301 and the track region 401 indicated by the river region information and the track region information acquired from the open space region information storage unit 22 as the open space region information, and the road 211 that is not stored in the open space region information storage unit 22 but actually exists as a main propagation path of radio waves.

The simplified map information generating unit 11 acquires map information including building information indicating the map illustrated in FIG. 2 from the map information storage unit 21, acquires the road information indicating the road 201 to the road 205 set by the open space region information setting unit 13 as open space region information, acquires the river region information indicating the river region 301 illustrated in FIG. 10 and the track region information indicating the track region 401 illustrated in FIG. 12 corresponding to the map information from the open space region information storage unit 22 as open space region information, and acquires additional road information indicating the road 211 that is not stored in the open space region information storage unit 22 but actually exists from the additional open space region information input unit 4 as open space region information.

The simplified map information generating unit 11 generates block region information in which a region obtained by excluding the road 201 to the road 205 indicated by the road information, the river region 301 indicated by the river region information, the track region 401 indicated by the track region information, and the road 211 indicated by the additional road information from the map indicated by the map information acquired from the map information storage unit 21 is set as the block region 501.

The simplified map information generating unit 11 generates simplified map information in which the map information is simplified in which the region obtained by excluding the road 201 to the road 205, the river region 301, the track region 401, and the added road 211 indicated by the open space region information on the map indicated by the map information is changed to the block region 501 indicated by the block region information.

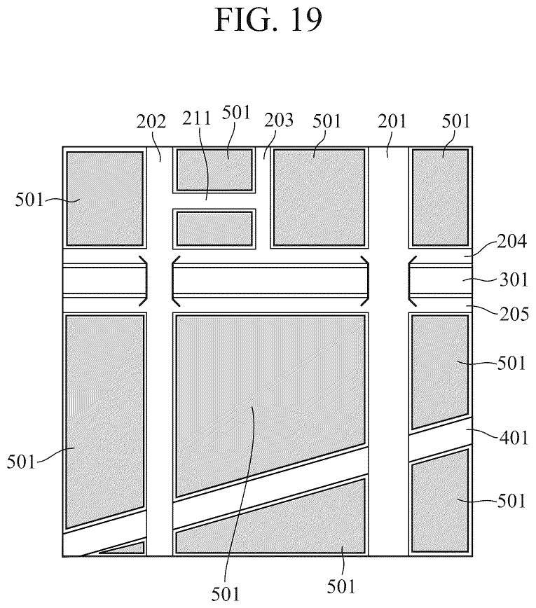

A simplified map represented by the simplified map information is illustrated in FIG. 19.

As illustrated in FIG. 19, in the region obtained by excluding the road 201 to the road 205 indicated by the road information, the river region 301 indicated by the river region information, the track region 401 indicated by the track region information, and the road 211 indicated by the additional road information, the road 206 to the road 210 indicated by the road information is also represented as a part of the block region 501.

Since the road 211 that actually exists is assumed as a main propagation path of radio waves, radio wave propagation can be analyzed by a simplified map close to the actual urban area structure.

The radio wave propagation analysis unit 12 and the display unit 3 operate in the same manner as the radio wave propagation analysis unit 12 and the display unit 3 in the fifth embodiment.

Similarly to the radio wave propagation analysis device 1 according to the fifth embodiment, the radio wave propagation analysis device 1 is implemented by a hardware configuration by the computer illustrated in FIG. 8.

The input unit 4A in the hardware configuration by the computer illustrated in FIG. 8 corresponds to the additional open space region information input unit 4.

The operation of the radio wave propagation analysis device 1 is also similar to the operation illustrated in FIG. 17 of the radio wave propagation analysis device 1 according to the fifth embodiment, and is different in that the additional open space region information input from the additional open space region information input unit 4 is added.

Hereinafter, differences will be mainly described.

Step ST1 is the same as step ST1 in the fifth embodiment.

Step ST2 is a step in which the open space region information setting unit 13 acquires the road information from the open space region information storage unit 22, the simplified map information generating unit 11 acquires the river region information and the track region information from the open space region information storage unit 22 as open space region information, and the simplified map information generating unit 11 acquires the additional road information from the additional open space region information input unit 4.

Step ST2A is the same as step ST2A in the fifth embodiment.

In step ST3, the simplified map information generating unit 11 generates block region information in which a region obtained by excluding the road 201 to the road 205 indicated by the road information set in step ST2A, the river region 301 and the track region 401 indicated by the river region information and the track region information acquired in step ST2, and the road 211 indicated by the additional road information acquired in step ST2 from the map indicated by the map information acquired in step ST2 is set as the block region 501.

Further, in step ST3, the simplified map information generating unit 11 generates simplified map information in which the map information is simplified in which the region obtained by excluding the road 201 to the road 205, the river region 301, the track region 401, and the added road 211 indicated by the open space region information including the road information, the river region information, the track region information, and the additional road information is changed to the block region 501 indicated by the block region information.

Step ST3 is a simplified map generating step.

Steps ST4 and ST5 are the same as steps ST4 and ST5 in the fifth embodiment.

In this manner, the radio wave propagation analysis device 1 executes radio wave propagation analysis and generates image information for displaying an image in which a radio wave propagation analysis result from the transmission point to the reception point is superimposed on the simplified map.

The radio wave propagation analysis method in steps ST1 to ST5 is performed by the CPU 1A executing processing according to a program stored in the ROM.

That is, the program stored in the ROM includes an information acquisition procedure of acquiring map information including building information and road information, river region information, and track region information corresponding to the map information, and acquiring additional road information, a procedure of classifying the acquired road information into a plurality of pieces of road information according to a road width and setting road information excluding road information classified as a narrowest road width as open space region information, a simplified map generation procedure of generating block region information in which a region obtained by excluding a road indicated by the road information set as the open space region information, a river region and a track region indicated by the river region information and the track region information acquired as open space region information, and an additional road indicated by the additional road information from a map indicated by the map information is set as a block region, and generating simplified map information in which the map information is simplified in which the region obtained by excluding the road indicated by the set road information, the river region and the track region indicated by the acquired river region information and track region information, and the additional road indicated by the acquired additional road information is changed to the block region indicated by block region information, and a radio wave propagation analysis procedure of performing radio wave propagation analysis on the basis of the simplified map information.

As described above, the radio wave propagation analysis device 1 in the radio wave propagation simulator according to the sixth embodiment includes the open space region information setting unit that classifies road information into a plurality of pieces of road information according to a road width indicated by the road information, and sets road information excluding road information classified as a narrowest road width as open space region information, the simplified map information generating unit 11 that generates block region information in which a region obtained by excluding the road 201 to the road 205 indicated by the road information which is the set open space region information, the river region 301 indicated by the river region information and the track region 401 indicated by the track region information which are open space region information, and the road 211 indicated by the additional road information which is open space region information from a map indicated by map information including building information is set as the block region 501, and generates simplified map information in which the map information is simplified in which the region obtained by excluding the road 201 to the road 205 indicated by the set road information, the river region 301 indicated by the river region information, the track region 401 indicated by the track region information, and the road 211 indicated by the additional road information is changed to the block region 501 indicated by the block region information, and the radio wave propagation analysis unit 12 that performs radio wave propagation analysis on the basis of the simplified map information, in which the road 211 that is not indicated by the road information but actually exists is assumed as a main propagation path of radio waves, and the radio wave propagation analysis is performed on the basis of the simplified map information in which a region other than the road 201 to the road 205, the river region 301, the track region 401, and the added road 211 that can be a main propagation path of radio waves is set as the block region, so that it is possible to use a simplified map closer to an actual urban area structure, remove a factor that causes degradation of analysis accuracy as much as possible, and further reduce a calculation amount required for radio wave propagation analysis, thereby accelerating calculation processing.

Note that, although the additional road information has been targeted as additional open space region information to be acquired from the additional open space region information input unit 4 by the simplified map information generating unit 11 of the radio wave propagation analysis device 1 in the radio wave propagation simulator according to the sixth embodiment, additional river region information or additional track region information may be set as the additional open space region information.

That is, for example, in a case where data extracted from digital elevation data of the Geospatial Information Authority of Japan or the like is used, the additional river region information is river region information indicating a river region when the river region is actually present other than the river region 301 indicated by the river region information stored in the open space region information storage unit 22 within the range of the map indicated by the map information stored in the map information storage unit 21.

For example, when data created by a map production company or the like is used, the additional track region information is track region information indicating a track region when the track region is actually present other than the track region 401 indicated by the track region information stored in the open space region information storage unit 22 within the range of the map indicated by the map information stored in the map information storage unit 21.

Further, in the radio wave propagation analysis device 1 in the radio wave propagation simulator according to the sixth embodiment, the simplified map information generating unit 11 acquires the additional open space region information from the additional open space region information input unit 4 for the radio wave propagation analysis device 1 in the radio wave propagation simulator according to the fifth embodiment, but the simplified map information generating unit 11 may acquire the additional open space region information from the additional open space region information input unit 4 for the radio wave propagation analysis device 1 in the radio wave propagation simulator according to the first embodiment, the simplified map information generating unit 11 may acquire the additional open space region information from the additional open space region information input unit 4 for the radio wave propagation analysis device 1 in the radio wave propagation simulator according to the second embodiment, the simplified map information generating unit 11 may acquire the additional open space region information from the additional open space region information input unit 4 for the radio wave propagation analysis device 1 in the radio wave propagation simulator according to the third embodiment, and the simplified map information generating unit 11 may acquire the additional open space region information from the additional open space region information input unit 4 for the radio wave propagation analysis device 1 in the radio wave propagation simulator according to the fourth embodiment.

### Seventh Embodiment

A radio wave propagation simulator including a radio wave propagation analysis device 1 according to a seventh embodiment will be described with reference to FIGS. 20, 2 to 4, 6 to 8, 10, 12, 17, and 21.

The radio wave propagation simulator according to the seventh embodiment is different from the radio wave propagation simulator according to the sixth embodiment in that antenna arrangement region information based on position information of a transmission point 601 and position information of a reception point 701 is added as open space region information, and the other points are the same.

In general, a reception point located outdoors is often arranged in an area with a space extending toward the sky.

In the seventh embodiment, a path in which a plurality of reception points is arranged along a region where a space extends toward the sky is assumed as a main propagation path of radio waves, and radio wave propagation is analyzed.

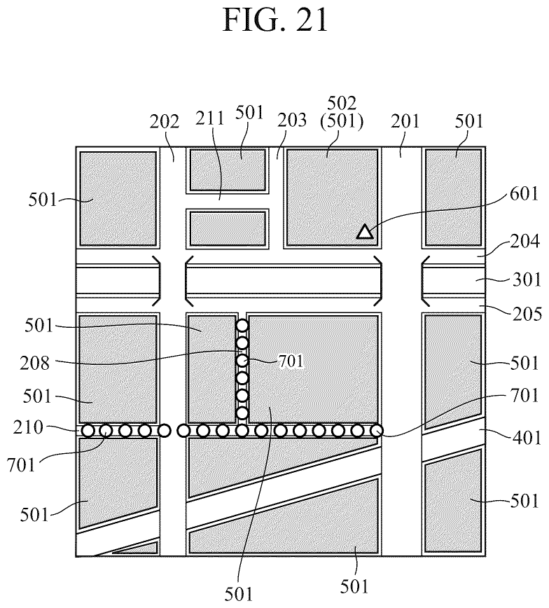

For example, in the radio wave propagation simulators according to the fifth embodiment and the sixth embodiment, in a case where road information excluding the road information indicating the road 206 to the road 210 classified as the narrowest road width by the open space region information setting unit 13 is set to the open space region information, when a plurality of reception points 701 is scattered along the excluded road 208 and road 210 as illustrated in FIG. 21, the road information indicating the road 208 and the road 210 is restored as the open space region information in the simplified map information generating unit 11 of the radio wave propagation analysis device 1 in the radio wave propagation simulator according to the seventh embodiment.

Similarly, when the plurality of reception points 701 is interspersed along the river region and the track region indicated by the river region information indicating the river region excluded from the open space region information by the open space region information setting unit 13 and the track region information indicating the track region excluded from the open space region information by the open space region information setting unit 13, the excluded river region and track region are restored as the open space region information by the simplified map information generating unit 11.

In addition, when the transmission point 601 exists in the block region 501 indicated by the block region information generated by the simplified map information generating unit 11, for example, as illustrated in FIG. 21, the simplified map information generating unit 11 generates open space region information in which a space equal to or higher than a height at which the transmission point 601 is set in a block region 502 (501) where the transmission point 601 exists is set as the open space region.

The space equal to or higher than the height at which the transmission point 601 is set can be assumed as a space in the entire sky direction from the rooftop of the building 101, and radio wave propagation is analyzed as a main propagation path of radio waves.

Considering the above points, the radio wave propagation simulator according to the seventh embodiment will be described focusing on differences from the radio wave propagation simulator according to the sixth embodiment.

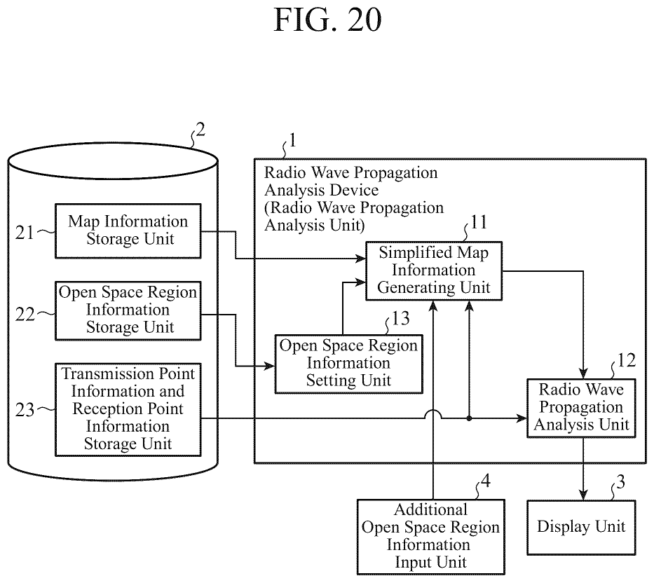

As illustrated in FIG. 20, the radio wave propagation simulator according to the seventh embodiment includes the radio wave propagation analysis device 1 including the simplified map information generating unit 11, the radio wave propagation analysis unit 12, and the open space region information setting unit 13, the storage unit 2 including the map information storage unit 21, the open space region information storage unit 22, the transmission point information and reception point information storage unit 23, the display unit 3, and the additional open space region information input unit 4.

The map information storage unit 21, the open space region information storage unit 22, and the transmission point information and reception point information storage unit 23 are the same as the map information storage unit 21, the open space region information storage unit 22, and the transmission point information and reception point information storage unit 23 in the fifth embodiment.

Further, the open space region information setting unit 13 is also the same as the open space region information setting unit 13 according to the fifth embodiment.

The simplified map information generating unit 11 acquires the position information of the transmission point and the position information of the reception point stored in the transmission point information and reception point information storage unit 23.

When determining that the positions of the reception points 701 indicated by the acquired position information of the plurality of reception points 701 are arranged along the path, the simplified map information generating unit 11 sets the path information indicating the path on which the plurality of reception points 701 is arranged as open space region information.

In this example, for example, the road 208 and the road 210 are assumed as an open space region as a path in which the plurality of reception points 701 is arranged, and road information indicating the road 208 and the road 210 is set as the open space region information according to the reception point 701.

The simplified map information generating unit 11 also acquires map information including building information indicating the map illustrated in FIG. 2 from the map information storage unit 21, acquires the road information indicating the road 201 to the road 205 set by the open space region information setting unit 13 as open space region information, acquires the river region information indicating the river region 301 illustrated in FIG. 10 and the track region information indicating the track region 401 illustrated in FIG. 12 corresponding to the map information from the open space region information storage unit 22 as open space region information, and acquires additional open space region information, additional road information indicating the road 211 in this example, from the additional open space region information input unit 4.

The simplified map information generating unit 11 generates block region information in which a region obtained by excluding the road 201 to the road 205 indicated by the road information, the river region 301 indicated by the river region information, the track region 401 indicated by the track region information, the road 211 indicated by the additional road information, and the region (the road 208 and the road 210) indicated by the open space region information according to the reception point 701 set by itself from the map indicated by the map information acquired from the map information storage unit 21 is set as the block region 501.

When the position of the transmission point 601 indicated by the acquired position information of the transmission point 601 exists in the block region 502 (501) indicated by the generated block region information, the simplified map information generating unit 11 generates open space region information in which a space region equal to or higher than the height of the transmission point 601 indicated by the position information of the transmission point 601 in the block region 502 where the transmission point 601 exists is set as an open space region according to the transmission point 601.

The simplified map information generating unit 11 generates simplified map information in which the map information is simplified in which the region obtained by excluding the road 201 to the road 205, the river region 301, the track region 401, the added road 211, and the road 208 and the road 210 indicated by the open space region information on the map indicated by the map information is changed to the block region 501 indicated by the block region information, and the region indicated by the open space region information according to the transmission point 601 is set as an open space region.

A simplified map represented by the simplified map information is illustrated in FIG. 21.

In FIG. 21, symbol Δ indicates the transmission point 601, and symbol ◯ indicates the reception point 701.

Since the additional open space region information is obtained from the position information of the transmission point 601 and the position information of the reception point 701, the accuracy of the radio wave propagation analysis is not deteriorated.

The radio wave propagation analysis unit 12 and the display unit 3 operate in the same manner as the radio wave propagation analysis unit 12 and the display unit 3 in the sixth embodiment.

Similarly to the radio wave propagation analysis device 1 according to the sixth embodiment, the radio wave propagation analysis device 1 is implemented by a hardware configuration by the computer illustrated in FIG. 8.

The operation of the radio wave propagation analysis device 1 is also similar to the operation illustrated in FIG. 17 in the radio wave propagation analysis device 1 according to the sixth embodiment, and is different in that antenna arrangement region information based on the position information of the transmission point 601 and the position information of the reception point 701 is added as open space region information.

Hereinafter, differences will be mainly described.

Step ST1 is the same as step ST1 in the sixth embodiment.

Step ST2 is a step in which the open space region information setting unit 13 acquires the road information from the open space region information storage unit 22, the simplified map information generating unit 11 acquires the river region information and the track region information from the open space region information storage unit 22 as open space region information, the simplified map information generating unit 11 acquires the additional open space region information from the additional open space region information input unit 4, and acquires the position information of the transmission point and the position information of the reception point stored in the transmission point information and reception point information storage unit 23.

Step ST2A is the same as step ST2A in the sixth embodiment.

In step ST3, when the simplified map information generating unit 11 determines that the positions of the reception points 701 indicated by the position information of the plurality of reception points 701 acquired in step ST2 are arranged along the path, in this example, for example, the road 208 and the road 210 are assumed as open space regions, and the road information indicating the road 208 and the road 210 is set as open space region information according to the reception points 701.

Further, in step ST3, the simplified map information generating unit 11 generates block region information in which a region obtained by excluding the road 201 to the road 205 indicated by the road information set in step ST2A, the river region 301 and the track region 401 indicated by the river region information and the track region information acquired in step ST2, the road 211 indicated by the additional road information acquired in step ST2, and the road 208 and the road 210 according to the reception point 701 set by itself in step ST3 from the map indicated by the map information acquired in step ST2 is set as the block region 501.

Further, in step ST3, when the position of the transmission point 601 indicated by the position information of the transmission point 601 acquired in step ST2 exists in the block region 502 indicated by the generated block region information, the simplified map information generating unit 11 generates open space region information in which a space equal to or higher than the height of the transmission point 601 indicated by the position information of the transmission point 601 in the block region 501 where the transmission point 601 exists is set as an open space region according to the transmission point 601.

Furthermore, in step ST3, the simplified map information generating unit 11 generates simplified map information in which the map information is simplified in which the region obtained by excluding the road 201 to the road 205, the river region 301, the track region 401, the added road 211, and the road 208 and the road 210 indicated by the open space region information including the road information, the river region information, the track region information, and the additional road information is changed to the block region 501 indicated by the block region information, and a region indicated by the open space region information according to the transmission point 601 is set as an open space region.

Step ST3 is a simplified map generating step.

Steps ST4 and ST5 are the same as steps ST4 and ST5 in the sixth embodiment.

In this manner, the radio wave propagation analysis device 1 executes radio wave propagation analysis and generates image information for displaying an image in which a radio wave propagation analysis result from the transmission point to the reception point is superimposed on the simplified map.

The radio wave propagation analysis method in steps ST1 to ST5 is performed by the CPU 1A executing processing according to a program stored in the ROM.

That is, the program stored in the ROM includes an information acquisition procedure of acquiring map information including building information and road information, river region information, and track region information corresponding to the map information, and acquiring additional road information, and acquiring position information of a transmission point and position information of a reception point, a procedure of classifying the acquired additional open space region information into a plurality of pieces of additional open space region information according to a width of an additional open space and setting additional open space region information excluding additional open space region information classified as a narrowest width of an additional open space as open space region information, a simplified map generation procedure of setting open space region information according to a reception point, generating block region information in which a region obtained by excluding a road indicated by road information set as the open space region information, a river region and a track region indicated by the river region information and the track region information acquired as open space region information, an additional road indicated by the additional road information, and an open space region indicated by the set open space region information according to the reception point from a map indicated by the map information is set as a block region, generating open space region information according to a transmission point existing in the generated block region, and generating simplified map information in which the map information is simplified in which the region obtained by excluding the road indicated by the set road information, the river region and the track region indicated by the acquired river region information and track region information, the additional road indicated by the acquired additional road information, and the open space region indicated by the set open space region information according to the reception point is changed to the block region indicated by block region information, and a region indicated by the open space region information according to the transmission point is set as an open space region, and a radio wave propagation analysis procedure of performing radio wave propagation analysis on the basis of the simplified map information.

As described above, the radio wave propagation analysis device 1 in the radio wave propagation simulator according to the seventh embodiment includes the open space region information setting unit that classifies road information into a plurality of pieces of road information according to a road width indicated by the road information, and sets road information excluding road information classified as a narrowest road width as open space region information, the simplified map information generating unit 11 that sets open space region information according to the reception point 701, generates block region information in which a region obtained by excluding the road 201 to the road 205 indicated by the road information which is the set open space region information, the river region 301 indicated by the river region information and the track region 401 indicated by the track region information which are open space region information, the road 211 indicated by the additional road information which is open space region information, and the road 208 and the road 210 indicated by the set open space region information according to the reception point 701 from a map indicated by map information including building information is set as the block region 501, generates simplified map information in which the map information is simplified in which the region obtained by excluding the road 201 to the road 205 indicated by the set road information, the river region 301 indicated by the river region information, the track region 401 indicated by the track region information, the road 211 indicated by the additional road information, and the road 208 and the road 210 indicated by the set road information is changed to the block region 501 indicated by the block region information, and a region indicated by open space region information according to the transmission point 601 is set as an open space region, and the radio wave propagation analysis unit 12 that performs radio wave propagation analysis on the basis of the simplified map information, in which the road 211 that is not indicated by the road information but actually exists is assumed as a main propagation path of radio waves, and the radio wave propagation analysis is performed on the basis of the simplified map information in which a region other than the road 201 to the road 205, the road 208 and the road 210, the river region 301, the track region 401, and the added road 211 that can be a main propagation path of radio waves is set as the block region, and the region indicated by the open space region information according to the transmission point 601 is set as an open space region, so that it is possible to use a simplified map closer to an actual urban area structure, remove a factor that causes degradation of analysis accuracy as much as possible, and further reduce a calculation amount required for radio wave propagation analysis, thereby accelerating calculation processing.

Note that the radio wave propagation analysis device 1 in the radio wave propagation simulator according to the seventh embodiment sets the open space region information according to the reception point 701 and sets the region indicated by the open space region information according to the transmission point 601 as the open space region in the radio wave propagation analysis device 1 in the radio wave propagation simulator according to the sixth embodiment, but may set the open space region information according to the reception point 701 and set the region indicated by the open space region information according to the transmission point 601 as the open space region in the radio wave propagation analysis device 1 in the radio wave propagation simulator according to the first embodiment, set the open space region information according to the reception point 701 and set the region indicated by the open space region information according to the transmission point 601 as the open space region in the radio wave propagation analysis device 1 in the radio wave propagation simulator according to the second embodiment, set the open space region information according to the reception point 701 and set the region indicated by the open space region information according to the transmission point 601 as the open space region in the radio wave propagation analysis device 1 in the radio wave propagation simulator according to the third embodiment set the open space region information according to the reception point 701 and set the region indicated by the open space region information according to the transmission point 601 as the open space region in the radio wave propagation analysis device 1 in the radio wave propagation simulator according to the fourth embodiment, and set the open space region information according to the reception point 701 and set the region indicated by the open space region information according to the transmission point 601 as the open space region in the radio wave propagation analysis device 1 in the radio wave propagation simulator according to the fifth embodiment.

### Eighth Embodiment

A radio wave propagation simulator including a radio wave propagation analysis device 1 according to an eighth embodiment will be described with reference to FIGS. 20, 2 to 4, 6 to 8, 10, 12, 17, and 22.

The radio wave propagation simulator according to the eighth embodiment is different from the radio wave propagation simulator according to the seventh embodiment in that propagation path information indicating a propagation path with good visibility for radio wave propagation from a position of a transmission point 602 indicated by position information of the transmission point 602 (601) to a position of a reception point 702 indicated by position information of the reception point 702 (701) is added, and the other points are the same.

In the eighth embodiment, when there is a path with good visibility from the position of the transmission point 602 to the position of the reception point 702, the path with good visibility is good as a propagation path of radio waves, and the radio wave propagation is analyzed assuming the path with good visibility as a main propagation path of radio waves.

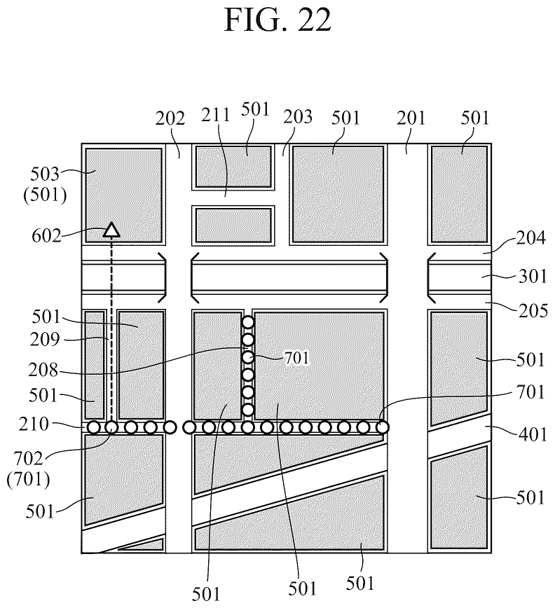

For example, in the radio wave propagation simulator according to the fifth to seventh embodiments, in a case where road information excluding road information indicating the road 209 classified as the narrowest road width by the open space region information setting unit 13 is set to the open space region information, as illustrated in FIG. 22, if visibility is good from the position of the transmission point 602 to the position of the reception point 702 along an excluded road 209, the simplified map information generating unit 11 of the radio wave propagation analysis device 1 in the radio wave propagation simulator according to the eighth embodiment restores the road information indicating the road 209 as the open space region information.

Similarly, if visibility is good from the position of the transmission point to the position of the reception point along the river region and the track region indicated by the river region information indicating the river region excluded from the open space region information and the track region information indicating the track region excluded from the open space region information by the open space region information setting unit 13, the simplified map information generating unit 11 restores the excluded river region and track region as the open space region information.

Considering on the above points, the radio wave propagation simulator according to the eighth embodiment will be described focusing on differences from the radio wave propagation simulator according to the seventh embodiment.

The radio wave propagation simulator according to the eighth embodiment includes the radio wave propagation analysis device 1 including the simplified map information generating unit 11, the radio wave propagation analysis unit 12, and the open space region information setting unit 13, the storage unit 2 including the map information storage unit 21, the open space region information storage unit 22, the transmission point information and reception point information storage unit 23, the display unit 3, and the additional open space region information input unit 4.

The map information storage unit 21, the open space region information storage unit 22, and the transmission point information and reception point information storage unit 23 are the same as the map information storage unit 21, the open space region information storage unit 22, and the transmission point information and reception point information storage unit 23 in the seventh embodiment.

Further, the open space region information setting unit 13 is also the same as the open space region information setting unit 13 in the seventh embodiment.

When determining that the visibility is good for radio wave propagation from the position of the transmission point 602 indicated by the acquired position information of the transmission point 602 to the position of the reception point 702 indicated by the position information of the reception point 702, the simplified map information generating unit 11 sets transmission path information indicating a propagation path with good visibility from the position of the transmission point 602 to the position of the reception point 702 as open space region information.

In this example, for example, the road 209 is assumed as an open space region as a propagation path with good visibility from the position of the transmission point 602 to the position of the reception point 702, and road information indicating the road 209 is set as the open space region information according to the transmission point 602 and the reception point 702.

The simplified map information generating unit 11 generates block region information in which a region obtained by excluding the road 201 to the road 205 indicated by the road information, the river region 301 indicated by the river region information, the track region 401 indicated by the track region information, the road 211 indicated by the additional road information, the region (the road 208 and the road 210) indicated by the open space region information according to the reception point 701 set by itself, and the region (the road 209) indicated by the open space region information according to the transmission point 602 and the reception point 702 set by itself from the map indicated by the map information acquired from the map information storage unit 21 is set as the block region 501.

The simplified map information generating unit 11 generates the simplified map information in which the map information is simplified in which the region obtained by excluding the road 201 to the road 205, the river region 301, the track region 401, the road 211, the road 208 and the road 210, and the road 209 indicated by the open space region information on the map indicated by the map information is changed to the block region 501 indicated by the block region information, and the region indicated by the open space region information according to the transmission point 602 is set as the open space region.

A simplified map represented by the simplified map information is illustrated in FIG. 22.

It is possible to generate a simplified map in which a path from the position of the transmission point 602 to the position of the reception point 702 with good visibility, which has a large influence on radio wave propagation, is secured.

The radio wave propagation analysis unit 12 and the display unit 3 operate in the same manner as the radio wave propagation analysis unit 12 and the display unit 3 in the seventh embodiment.

Similarly to the radio wave propagation analysis device 1 according to the seventh embodiment, the radio wave propagation analysis device 1 is implemented by a hardware configuration by the computer illustrated in FIG. 8.

The operation of the radio wave propagation analysis device 1 is similar to the operation of the radio wave propagation analysis device 1 according to the seventh embodiment, and is different in that propagation path information indicating a propagation path with good visibility for radio wave propagation from the position of the transmission point 602 to the position of the reception point 702 is added.

Hereinafter, differences will be mainly described.

Steps ST1, ST2, and ST2A are the same as steps ST1, ST2, and ST2A in the seventh embodiment.

In step ST3, when the simplified map information generating unit 11 determines that the visibility is good from the position of the transmission point 602 indicated by the position information of the transmission point 602 acquired in step ST2 to the position of the reception point 702 indicated by the position information of the reception point 702, a path from the position of the transmission point 602 to the position of the reception point 702, for example, road information indicating the road 209 by assuming the road 209 as an open space region is set as the open space region information according to the transmission point 602 and the reception point 702.

Further, in step ST3, the simplified map information generating unit 11 generates block region information in which a region obtained by excluding the road 201 to the road 205 indicated by the road information set in step ST2A, the river region 301 and the track region 401 indicated by the river region information and the track region information acquired in step ST2, the road 211 indicated by the additional road information acquired in step ST2, the road 208 and the road 210 according to the reception point 701 set by itself in step ST3, and the road 209 according to the transmission point 602 and the reception point 702 set by itself in step ST3 from the map indicated by the map information acquired in step ST2 is set as the block region 501.

Further, in step ST3, when the position of the transmission point 602 indicated by the position information of the transmission point 602 acquired in step ST2 exists in the block region 503 (501) indicated by the generated block region information, the simplified map information generating unit 11 generates open space region information in which a space equal to or higher than the height of the transmission point 602 indicated by the position information of the transmission point 602 in the block region 503 where the transmission point 602 exists is set as an open space region according to the transmission point 602.

Furthermore, in step ST3, the simplified map information generating unit 11 generates simplified map information in which the map information is simplified in which the region obtained by excluding the road 201 to the road 205, the river region 301, the track region 401, the added road 211, the road 208 and the road 210, and the road 209 indicated by the open space region information including the road information, the river region information, the track region information, and the additional road information is changed to the block region 501 indicated by the block region information, and a region indicated by the open space region information according to the transmission point 602 is set as an open space region.

Step ST3 is a simplified map generating step.

Steps ST4 and ST5 are the same as steps ST4 and ST5 in the seventh embodiment.

In this manner, the radio wave propagation analysis device 1 executes radio wave propagation analysis and generates image information for displaying an image in which a radio wave propagation analysis result from the transmission point to the reception point is superimposed on the simplified map.

The radio wave propagation analysis method in steps ST1 to ST5 is performed by the CPU 1A executing processing according to a program stored in the ROM.

That is, the program stored in the ROM includes an information acquisition procedure of acquiring map information including building information and road information, river region information, and track region information corresponding to the map information, and acquiring additional road information, and acquiring position information of a transmission point and position information of a reception point, a procedure of classifying the acquired additional open space region information into a plurality of pieces of additional open space region information according to a width of an additional open space and setting additional open space region information excluding additional open space region information classified as a narrowest width of an additional open space as open space region information, a simplified map generation procedure of setting open space region information according to a reception point, setting open space region information according to a transmission point and a reception point, generating block region information in which a region obtained by excluding a road indicated by road information set as the open space region information, a river region and a track region indicated by the river region information and the track region information acquired as open space region information, an additional road indicated by the additional road information, an open space region indicated by the set open space region information according to the reception point, and an open space region indicated by the set open space region information according to the transmission point and the reception point from a map indicated by the map information is set as a block region, generating open space region information according to a transmission point existing in the generated block region, and generating simplified map information in which the map information is simplified in which the region obtained by excluding the road indicated by the set road information, the river region and the track region indicated by the acquired river region information and track region information, the additional road indicated by the acquired additional road information, the open space region indicated by the set open space region information according to the reception point, and the open space region indicated by the set open space region information according to the transmission point and the reception point is changed to a block region indicated by block region information, and a region indicated by the open space region information according to the transmission point is set as an open space region, and a radio wave propagation analysis procedure of performing radio wave propagation analysis on the basis of the simplified map information.

As described above, the radio wave propagation analysis device 1 in the radio wave propagation simulator according to the eighth embodiment includes the open space region information setting unit that classifies road information into a plurality of pieces of road information according to a road width indicated by the road information, and sets road information excluding road information classified as a narrowest road width as open space region information, the simplified map information generating unit 11 that sets open space region information according to the reception point 701, sets open space region information according to the transmission point 602 and the reception point 702, generates block region information in which a region obtained by excluding the road 201 to the road 205 indicated by the road information which is the set open space region information, the river region 301 indicated by the river region information and the track region 401 indicated by the track region information which are open space region information, the road 211 indicated by the additional road information which is open space region information, the road 208 and the road 210 indicated by the set open space region information according to the reception point 701, and the road 209 indicated by the set open space region information according to the transmission point 602 and the reception point 702 from a map indicated by map information including building information is set as the block region 501, generates simplified map information in which the map information is simplified in which the region obtained by excluding the road 201 to the road 205 indicated by the set road information, the river region 301 indicated by the river region information, the track region 401 indicated by the track region information, the road 211 indicated by the additional road information, and the road 208 and the road 210 and the road 209 indicated by the set road information is changed to the block region 501 indicated by the block region information, and a region indicated by open space region information according to the transmission point 602 is set as an open space region, and the radio wave propagation analysis unit 12 that performs radio wave propagation analysis on the basis of the simplified map information, in which the road 211 that is not indicated by the road information but actually exists is assumed as a main propagation path of radio waves, and the radio wave propagation analysis is performed on the basis of the simplified map information in which a region other than the road 201 to the road 205, the road 208 and the road 210, the road 209, the river region 301, the track region 401, and the added road 211 that can be a main propagation path of radio waves is set as the block region, and the region indicated by the open space region information according to the transmission point 602 is set as an open space region, so that it is possible to use a simplified map closer to an actual urban area structure, remove a factor that causes degradation of analysis accuracy as much as possible, and further reduce a calculation amount required for radio wave propagation analysis, thereby accelerating calculation processing.

Note that the radio wave propagation analysis device 1 in the radio wave propagation simulator according to the eighth embodiment is configured so that the open space region information according to the transmission point 602 and the reception point 702 is newly set in the radio wave propagation analysis device 1 in the radio wave propagation simulator according to the seventh embodiment, but may be configured so that the open space region information according to the transmission point 602 and the reception point 702 is set in the radio wave propagation analysis device 1 in the radio wave propagation simulator according to the first embodiment, the open space region information according to the transmission point 602 and the reception point 702 is newly set in the radio wave propagation analysis device 1 in the radio wave propagation simulator according to the second embodiment, the open space region information according to the transmission point 602 and the reception point 702 is newly set in the radio wave propagation analysis device 1 in the radio wave propagation simulator according to the third embodiment, the open space region information according to the transmission point 602 and the reception point 702 is newly set in the radio wave propagation analysis device 1 in the radio wave propagation simulator according to the fourth embodiment, the open space region information according to the transmission point 602 and the reception point 702 is newly set in the radio wave propagation analysis device 1 in the radio wave propagation simulator according to the fifth embodiment, and the open space region information according to the transmission point 602 and the reception point 702 is newly set in the radio wave propagation analysis device 1 in the radio wave propagation simulator according to the sixth embodiment.

### Ninth Embodiment

A radio wave propagation simulator including a radio wave propagation analysis device 1 according to a ninth embodiment will be described with reference to FIGS. 20, 2 to 4, 6 to 8, 10, 12, 17, and 23.

The radio wave propagation simulator according to the ninth embodiment is different from the radio wave propagation simulator according to the eighth embodiment in that open space region information indicating a space region that is not a road, a river region, and a track region but exists between buildings 101 and has a width equal to or larger than a set width and a length equal to or larger than a set length is added, and the other points are the same.

In the radio wave propagation simulator according to the eighth embodiment, a block region is created by mainly using a road, a river region, and a track region as open space regions. In this case, there may be a space region that can serve as a propagation path of radio waves between the buildings 101 in the block region.

In the ninth embodiment, radio wave propagation is analyzed by assuming a space region that can be a propagation path of radio waves between buildings 101 in a block region as a main propagation path of radio waves.

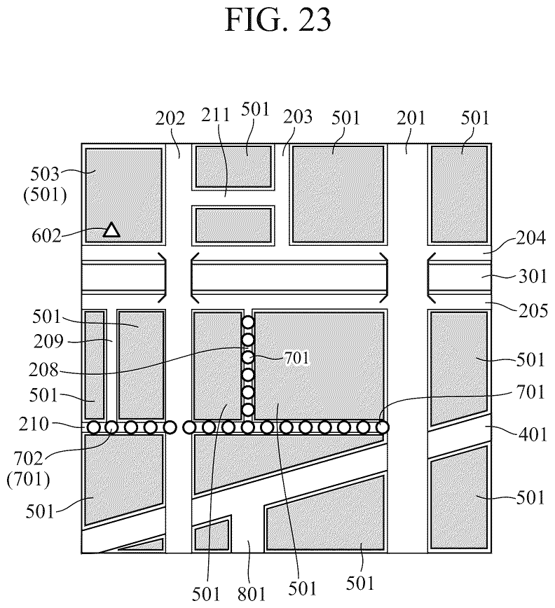

For example, as illustrated in FIG. 2, a space region 801 in FIG. 23 has a width equal to or larger than the set width and a length equal to or larger than the set length existing between the buildings 101.

In the ninth embodiment, this space region is also treated as an open space region, so that good radio wave propagation is analyzed.

Considering on the above points, the radio wave propagation simulator according to the ninth embodiment will be described focusing on differences from the radio wave propagation simulator according to the eighth embodiment.

The radio wave propagation simulator according to the ninth embodiment includes the radio wave propagation analysis device 1 including the simplified map information generating unit 11, the radio wave propagation analysis unit 12, and the open space region information setting unit 13, the storage unit 2 including the map information storage unit 21, the open space region information storage unit 22, the transmission point information and reception point information storage unit 23, the display unit 3, and the additional open space region information input unit 4.

The map information storage unit 21, the open space region information storage unit 22, and the transmission point information and reception point information storage unit 23 are the same as the map information storage unit 21, the open space region information storage unit 22, and the transmission point information and reception point information storage unit 23 in the eighth embodiment.

Further, the open space region information setting unit 13 is also the same as the open space region information setting unit 13 according to the fifth embodiment.

The simplified map information generating unit 11 generates block region information in which a region obtained by excluding the road 201 to the road 205 indicated by the road information, the river region 301 indicated by the river region information, the track region 401 indicated by the track region information, the road 211 indicated by the additional road information, the region (the road 208 and the road 210) indicated by the open space region information according to the reception point 701 set by itself, and the region (the road 209) indicated by the open space region information according to the transmission point 602 and the reception point 702 set by itself from the map indicated by the map information acquired from the map information storage unit 21 is set as the block region 501.

The simplified map information generating unit 11 extracts building information indicating the building 101 in each block region 501 indicated by each block region information generated from the map indicated by the map information acquired from the map information storage unit 21, and when it is determined that a space region 801 exists with good visibility having a width equal to or larger than a width set between the buildings 101 and a length equal to or larger than a set length in the block region 501, transmission path information indicating the space region 801 is set as open space region information.

Since the simplified map information generating unit 11 newly sets the open space region information indicating the space region 801, the block region information representing the block region 501 is recreated on the basis of the open space region information indicating the space region 801 with respect to the block region information indicating the previously generated block region 501.

In this example, the block region information in which the block region 501 is changed to block regions 501 divided into two by the space region 801 is recreated.

The simplified map information generating unit 11 generates the simplified map information in which the map information is simplified in which the region obtained by excluding the road 201 to the road 205, the river region 301, the track region 401, the road 211, the road 208, the road 210, the road 209, and the space region 801 indicated by the open space region information on the map indicated by the map information is changed to the block region 501 indicated by the block region information, and the region indicated by the open space region information according to the transmission point 602 is set as the open space region.

A simplified map represented by the simplified map information is illustrated in FIG. 23.

The radio wave propagation analysis unit 12 and the display unit 3 operate in the same manner as the radio wave propagation analysis unit 12 and the display unit 3 in the eighth embodiment.

Similarly to the radio wave propagation analysis device 1 according to the eighth embodiment, the radio wave propagation analysis device 1 is implemented by a hardware configuration by the computer illustrated in FIG. 8.

The operation of the radio wave propagation analysis device 1 is also similar to the operation of the radio wave propagation analysis device 1 according to the eighth embodiment, and is different in that when it is determined that the space region 801 exists in the generated block region 501, the block region 501 in which the space region 801 has existed is set as a re-created block region 501.

Hereinafter, differences will be mainly described.

Steps ST1, ST2, and ST2A are the same as steps ST1, ST2, and ST2A in the seventh embodiment.

In step ST3, the simplified map information generating unit 11 generates block region information in which a region obtained by excluding the road 201 to the road 205 indicated by the road information set in step ST2A, the river region 301 and the track region 401 indicated by the river region information and the track region information acquired in step ST2, the road 211 indicated by the additional road information acquired in step ST2, the road 208 and the road 210 according to the reception point 701 set by itself in step ST3, and the road 209 according to the transmission point 602 and the reception point 702 set by itself in step ST3 from the map indicated by the map information acquired in step ST2 is set as the block region 501.

In addition, in step ST3, the simplified map information generating unit 11 extracts building information indicating the building 101 in each block region 501 indicated by each block region information generated from the map indicated by the map information acquired in step ST2, and when it is determined that the space region 801 exists with good visibility having a width equal to or larger than the set width and a length equal to or larger than the set length existing between the buildings 101 in the block region 501, the transmission path information indicating the space region 801 is set as the open space region information.

Furthermore, since the simplified map information generating unit 11 newly sets the open space region information indicating the space region 801 in step ST3, the block region information representing the block region 501 is recreated on the basis of the open space region information indicating the space region 801 with respect to the block region information representing the block region 501 generated in advance.

Furthermore, in step ST3, the simplified map information generating unit 11 generates the simplified map information in which the map information is simplified in which the block region is changed to the block region 501 on the basis of the block region information indicating the re-created block region 501, and the region indicated by the open space region information according to the transmission point 602 is set as the open space region.

Step ST3 is a simplified map generating step.

Steps ST4 and ST5 are the same as steps ST4 and ST5 in the seventh embodiment.

In this manner, the radio wave propagation analysis device 1 executes radio wave propagation analysis and generates image information for displaying an image in which a radio wave propagation analysis result from the transmission point to the reception point is superimposed on the simplified map.

The radio wave propagation analysis method in steps ST1 to ST5 is performed by the CPU 1A executing processing according to a program stored in the ROM.

That is, the program stored in the ROM includes an information acquisition procedure of acquiring map information including building information and road information, river region information, and track region information corresponding to the map information, and acquiring additional road information, and acquiring position information of a transmission point and position information of a reception point, a procedure of classifying the acquired additional open space region information into a plurality of pieces of additional open space region information according to a width of an additional open space and setting additional open space region information excluding additional open space region information classified as a narrowest width of an additional open space as open space region information, a simplified map generation procedure of setting open space region information according to a reception point, setting open space region information according to a transmission point and a reception point, generating block region information in which a region obtained by excluding a road indicated by road information set as the open space region information, a river region and a track region indicated by the river region information and the track region information acquired as open space region information, an additional road indicated by the additional road information, an open space region indicated by the set open space region information according to the reception point, and an open space region indicated by the set open space region information according to the transmission point and the reception point from a map indicated by the map information is set as a block region, recreating, when a space region exists with good visibility having a width equal to or larger than a set width and a length equal to or larger than a set length between buildings in the generated block region, block region information in which transmission path information indicating the space region is set as open space region information, and generating simplified map information in which the map information is simplified in which the block region is changed to a block region indicated by the recreated block region information, and a region indicated by the open space region information according to the transmission point is set as an open space region, and a radio wave propagation analysis procedure of performing radio wave propagation analysis on the basis of the simplified map information.

As described above, the radio wave propagation analysis device 1 in the radio wave propagation simulator according to the ninth embodiment includes the open space region information setting unit that classifies road information into a plurality of pieces of road information according to a road width indicated by the road information, and sets road information excluding road information classified as a narrowest road width as open space region information, the simplified map information generating unit 11 that sets open space region information according to the reception point 701, sets open space region information according to the transmission point 602 and the reception point 702, generates block region information in which a region obtained by excluding the road 201 to the road 205 indicated by the road information which is the set open space region information, the river region 301 indicated by the river region information and the track region 401 indicated by the track region information which are open space region information, the road 211 indicated by the additional road information which is open space region information, the road 208 and the road 210 indicated by the set open space region information according to the reception point 701, and the road 209 indicated by the set open space region information according to the transmission point 602 and the reception point 702 from a map indicated by map information including building information is set as the block region 501, sets, when a space region 801 with good visibility having a width equal to or larger than a set width and a length equal to or larger than a set length exists between buildings 101 in the generated block region, block region information in which transmission path information indicating the space region 801 as open space region information, and generates simplified map information in which the map information is simplified in which the region obtained by excluding the road 201 to the road 205 indicated by the set road information, the river region 301 indicated by the river region information, the track region 401 indicated by the track region information, the road 211 indicated by the additional road information, the road 208 and the road 210 indicated by the set road information, the road 209, and the set space region 801 is changed to the block region 501 indicated by the block region information, and a region indicated by open space region information according to the transmission point 602 is set as an open space region, and the radio wave propagation analysis unit 12 that performs radio wave propagation analysis on the basis of the simplified map information, in which the road 211 that is not indicated by the road information but actually exists is assumed as a main propagation path of radio waves, and the radio wave propagation analysis is performed on the basis of the simplified map information in which a region other than the road 201 to the road 205, the road 208 and the road 210, the road 209, the river region 301, the track region 401, and the road 211 that can be a main propagation path of radio waves, and the space region 801 that can be a propagation path of radio waves is set as the block region, and the region indicated by the open space region information according to the transmission point 602 is set as an open space region, so that it is possible to use a simplified map closer to an actual urban area structure, remove a factor that causes degradation of analysis accuracy as much as possible, and further reduce a calculation amount required for radio wave propagation analysis, thereby accelerating calculation processing.

Note that the radio wave propagation analysis device 1 in the radio wave propagation simulator according to the ninth embodiment is configured so that the open space region information according to the space area that can serve as a propagation path of radio waves existing between the buildings 101 is newly set in the block region in the radio wave propagation analysis device 1 in the radio wave propagation simulator according to the eighth embodiment, but may be configured so that the open space region information according to the space area that can serve as a propagation path of radio waves existing between the buildings 101 is newly set in the block region to the radio wave propagation analysis device 1 in the radio wave propagation simulator according to the first embodiment, the open space region information according to the space area that can serve as a propagation path of radio waves existing between the buildings 101 is newly set in the block region to the radio wave propagation analysis device 1 in the radio wave propagation simulator according to the second embodiment, the open space region information according to the space area that can serve as a propagation path of radio waves existing between the buildings 101 is newly set in the block region to the radio wave propagation analysis device 1 in the radio wave propagation simulator according to the third embodiment, the open space region information according to the space area that can serve as a propagation path of radio waves existing between the buildings 101 is newly set in the block region to the radio wave propagation analysis device 1 in the radio wave propagation simulator according to the fourth embodiment, the open space region information according to the space area that can serve as a propagation path of radio waves existing between the buildings 101 is newly set in the block region to the radio wave propagation analysis device 1 in the radio wave propagation simulator according to the fifth embodiment, the open space region information according to the space area that can serve as a propagation path of radio waves existing between the buildings 101 is newly set in the block region to the radio wave propagation analysis device 1 in the radio wave propagation simulator according to the sixth embodiment, and the open space region information according to the space area that can serve as a propagation path of radio waves existing between the buildings 101 is newly set in the block region to the radio wave propagation analysis device 1 in the radio wave propagation simulator according to the seventh embodiment.

Note that free combinations of the respective embodiments, modifications of any components of the respective embodiments, or omissions of any components in the respective embodiments are possible.

### INDUSTRIAL APPLICABILITY

The radio wave propagation analysis device according to the present disclosure is suitable for a radio wave propagation analysis device that performs analysis of radio wave propagation from a transmission point to a reception point in a communication system.

### REFERENCE SIGNS LIST

1: radio wave propagation analysis device (radio wave propagation analysis unit), 11: simplified map information generating unit, 12: radio wave propagation analysis unit, 13: open space region information setting unit, 2: storage unit, 21: map information storage unit, 22: open space information storage unit, 23: transmission point information and reception point information storage unit, 3: display unit, 4: additional open space information input unit, 101: building, 201: first category road, 202: second category road, 203 to 205: third category road, 206 to 210: fourth category road, 301: river region, 401: track region, 501 to 503: block region

1. A radio wave propagation analysis device comprising:
a processor; and
a memory storing a program performing, upon executed by the processor, a process:
to acquire map information including building information and open space region information corresponding to the map information, generate block region information in which a region obtained by excluding a region indicated by the open space region information from a map indicated by the map information is set as a block region, and generate simplified map information in which the map information is simplified in which the region obtained by excluding the region indicated by the open space region information is changed to a block region indicated by the block region information; and
to perform radio wave propagation analysis on the basis of the simplified map information.

2. The radio wave propagation analysis device according to claim 1, wherein
the map information acquired is two-dimensional map data indicating a map of a two-dimensional plane viewed from above, and
the simplified map information generated is three-dimensional simplified map data having a height with respect to the block region.

3. The radio wave propagation analysis device according to claim 1, wherein
the map information acquired is three-dimensional map data indicating a three-dimensional map viewed from above, and
the simplified map information generated is three-dimensional simplified map data corresponding to the three-dimensional map data and having a height with respect to the block region.

4. The radio wave propagation analysis device according to claim 3, wherein the process further comprises to calculate a median height between a height of a highest building and a height of a lowest building in the map information existing in each of block regions, and sets information based on the median height as height information for each of the block regions in the simplified map information.

5. The radio wave propagation analysis device according to claim 3, wherein the process further comprises to calculate an average value or a weighted average value calculated from heights of a plurality of buildings in the map information existing in each of block regions, and sets information based on the average value or the weighted average value as height information for each of the block regions in the simplified map information.

6. The radio wave propagation analysis device according to claim 1, wherein the open space region information acquired is open space region information of at least one of road information, river region information, or track region information.

7. The radio wave propagation analysis device according to claim 6, wherein
the open space region information includes road information,
the process further comprises to classify the road information into a plurality of pieces of road information according to a road width indicated by the road information, and set road information as open space region information by excluding road information classified into a narrowest road width, and
road information that is the open space region information acquired is road information set by excluding the road information classified into a narrowest road width.

8. The radio wave propagation analysis device according to claim 6, wherein
the open space region information includes river region information,
the process further comprises to classify the river region information into a plurality of pieces of river region information according to a river region width indicated by the river region information, and set river region information as open space region information by excluding river region information classified into a narrowest river region width, and
river region information that is the open space region information acquired is river region information set by excluding the river region information classified into a narrowest river region width.

9. The radio wave propagation analysis device according to claim 6, wherein
the open space region information includes track region information,
the process further comprises to classify the track region information into a plurality of pieces of track region information according to a track region width indicated by the track region information, and set track region information as open space region information by excluding track region information classified into a narrowest track region width, and
track region information that is the open space region information acquired is track region information set by excluding the track region information classified into a narrowest track region width.

10. The radio wave propagation analysis device according to claim 1, wherein the open space region information acquired includes additional open space region information designated other than the open space region information corresponding to the map information.

11. The radio wave propagation analysis device according to claim 10, wherein the additional open space region information designated is at least one of additional road information, additional river region information, or additional track region information.

12. The radio wave propagation analysis device according to claim 1, wherein the process further comprises to handle, as open space region information, path information indicating a path in which a plurality of reception points is arranged.

13. The radio wave propagation analysis device according to claim 1, wherein the process further comprises to handle, as open space region information, space region information indicating a space region equal to or higher than a height at which a transmission point is located in the block region indicated by the block region information in which the transmission point exists.

14. The radio wave propagation analysis device according to claim 1, wherein the process further comprises to handle, as open space region information, transmission path information indicating a propagation path with good visibility for radio wave propagation from a position of a transmission point to a position of a reception point.

15. The radio wave propagation analysis device according to claim 1, wherein the process further comprises to handle, as open space region information, space region information indicating a space region having a width equal to or larger than a set width and a length equal to or larger than a set length existing between buildings in the block region indicated by the block region information.

16. The radio wave propagation analysis device according to claim 1, wherein the radio wave propagation analysis performed is a radio wave propagation characteristic analysis method of either ray tracing or FDTD method.

17. A radio wave propagation analysis method, comprising:
acquiring map information including building information and open space region information corresponding to the map information;
generating block region information in which a region obtained by excluding a region indicated by the open space region information from a map indicated by the map information is set as a block region, and generating simplified map information in which the map information is simplified in which the region obtained by excluding the region indicated by the open space region information is changed to a block region indicated by the block region information; and
performing radio wave propagation analysis on a basis of the simplified map information.

18. The radio wave propagation analysis method according to claim 17, wherein
the map information acquired is two-dimensional map data indicating a map of a two-dimensional plane viewed from above, and
the simplified map information generated is three-dimensional simplified map data having a height with respect to the block region.

19. The radio wave propagation analysis method according to claim 17, wherein
the map information acquired is three-dimensional map data indicating a three-dimensional map viewed from above, and
the simplified map information generated is three-dimensional simplified map data corresponding to the three-dimensional map data and having a height with respect to the block region.

20. The radio wave propagation analysis method according to claim 19, wherein height information for each of block regions in the simplified map information generated is information based on a median height between a height of a highest building and a height of a lowest building, which are calculated in the map information existing in each of the block regions.

21. The radio wave propagation analysis method according to claim 19, wherein height information for each of block regions in the simplified map information generated is information based on an average value or a weighted average value calculated from heights of a plurality of buildings in the map information existing in each of the block regions.

22. The radio wave propagation analysis method according to claim 17, wherein the open space region information acquired is open space region information of at least one of road information, river region information, or track region information.

23. The radio wave propagation analysis method according to claim 22, wherein
the open space region information acquired includes road information,
the radio wave propagation analysis method further comprises classifying the road information into a plurality of pieces of road information according to a road width indicated by the road information, and setting road information as open space region information by excluding road information classified into a narrowest road width, and
road information that is the open space region information acquired is road information set by excluding the road information classified into a narrowest road width.

24. The radio wave propagation analysis method according to claim 22, wherein
the open space region information acquired includes river region information,
the radio wave propagation analysis method further comprises classifying the river region information into a plurality of pieces of river region information according to a river region width indicated by the river region information, and setting river region information as open space region information by excluding river region information classified into a narrowest river region width, and
river region information that is the open space region information acquired is river region information set by excluding the river region information classified into a narrowest river region width.

25. The radio wave propagation analysis method according to claim 22, wherein
the open space region information acquired includes track region information,
the radio wave propagation analysis method further comprises classifying the track region information into a plurality of pieces of track region information according to a track region width indicated by the track region information, and setting track region information as open space region information by excluding track region information classified into a narrowest track region width, and
track region information that is the open space region information acquired is track region information set by excluding the track region information classified into a narrowest track region width.

26. The radio wave propagation analysis method according to claim 17, wherein the open space region information acquired includes additional open space region information designated other than the open space region information corresponding to the map information.

27. The radio wave propagation analysis method according to claim 26, wherein the additional open space region information designated is at least one of additional road information, additional river region information, or additional track region information.

28. The radio wave propagation analysis method according to claim 17, wherein the open space region information acquired includes path information indicating a path in which positions of a plurality of reception points are arranged.

29. The radio wave propagation analysis method according to claim 17, wherein the method further comprises generating simplified map information indicating a simplified map in which a space region equal to or higher than a height at which a transmission point is located in the block region indicated by the block region information in which the transmission point exists is set as an open space region.

30. The radio wave propagation analysis method according to claim 17, wherein the open space region information acquired includes transmission path information indicating a propagation path with good visibility for radio wave propagation from a position of a transmission point to a position of a reception point.

31. The radio wave propagation analysis method according to claim 17, wherein the method includes, as open space region information, space region information indicating a space region having a width equal to or larger than a set width and a length equal to or larger than a set length existing between buildings in the block region indicated by the block region information.

32. The radio wave propagation analysis method according to claim 17, wherein the radio wave propagation analysis performed is a radio wave propagation characteristic analysis method of either ray tracing or FDTD method.

33. A non-transitory, tangible computer readable recording medium storing a program for causing a computer to execute:
acquiring map information including building information and open space region information corresponding to the map information;
generating block region information in which a region obtained by excluding a region indicated by the open space region information from a map indicated by the map information is set as a block region;
generating simplified map information in which the map information is simplified in which the region obtained by excluding the region indicated by the open space region information is changed to a block region indicated by the block region information; and
performing radio wave propagation analysis on a basis of the simplified map information.
